(19) United States
(12) Patent Application Publication
(10) Pub. No.: US 2024/0222813 A1
(43) Pub. Date: Jul. 4, 2024

(54) SYSTEMS AND METHODS FOR BATTERY MANUFACTURE

(71) Applicant: Rivian IP Holdings, LLC, Plymouth, MI (US)

(72) Inventors: Meiyu Zhai, South San Francisco, CA (US); Prathamesh Bilgunde, Sunnyvale, CA (US); Daniel John Bayat, Reno, NV (US); Arvinth Chandar Rathinam, Sunnyvale, CA (US)

(21) Appl. No.: 18/314,570

(22) Filed: May 9, 2023

Related U.S. Application Data
(60) Provisional application No. 63/477,457, filed on Dec. 28, 2022.

(51) Int. Cl. H01M 50/536; H01M 10/0525; H01M 10/0585; H01M 50/54; H01M 50/566

(52) U.S. Cl. CPC H01M 50/536; H01M 10/0525; H01M 10/0585; H01M 50/54; H01M 50/566

(57) ABSTRACT

A method of manufacturing a battery cell is disclosed. The method can include emitting, by a laser welding device for a first duration, a first beam to pre-weld a first member with a current collector. The method can further include emitting, by the laser welding device for a second duration, a second beam to weld the first member with the current collector. The method can include the first duration of the first beam being less than the second duration of the second beam.

### CROSS REFERENCE TO RELATED PATENT APPLICATION

This application claims the benefit of and priority to U.S. Provisional Patent Application No. 63/477,457, filed Dec. 28, 2022, which is incorporated herein by reference in its entirety.

### INTRODUCTION

A battery can be used to operate a vehicle or components thereof.

### SUMMARY

The disclosed solutions have a technical advantage of pre-welding and welding a first member (e.g., an electrode stack tab or a terminal of a battery cell) with a current collector via a laser welding device. The laser welding device can include a laser element to emit a first beam (e.g., a single pulse beam or some other beam) to pre-weld the electrode stack tab with the current collector. The laser welding device can emit a second beam (e.g., a continuous wave beam or some other beam) to then weld the electrode stack tab with the current collector. For example, the laser welding device can emit at least one single pulse beam to pre-weld the electrode stack tab with the current collector during a first operation. The single pulse beam can create a joint to couple the individual electrode tabs of the electrode stack tab together to form a unitary (e.g., combined, unified, integrated) electrode stack tab. The single pulse beam can create the joint to couple the electrode stack tab with the current collector at the joint. The single pulse beam can cause a localized (e.g., thermally non-linear) reaction within the electrode stack tab and the current collector to prevent the current collector or the electrode stack tab from substantially melting (e.g., ±90% melting). The same (or different) laser welding device can emit a continuous wave beam during a second operation. The continuous wave beam can weld the electrode stack tab with the current collector. For example, the continuous wave beam can at least partially melt the electrode stack tab and the current collector to create a weld pool. The laser welding device can emit the continuous wave beam in a pattern or in a particular manner to facilitate or promote welding of the electrode stack tab with the current collector.

At least one aspect is directed to a method. The method can include emitting, by a laser welding device for a first duration, a first beam (e.g., a single pulse beam or some other beam) to pre-weld a first member with a current collector. The method can further include emitting, by the laser welding device for a second duration, a second beam (e.g., a continuous wave beam or some other beam) to weld the first member with the current collector. The method can include the first duration of the single pulse beam being less than the second duration of the continuous wave beam.

At least one aspect is directed to an apparatus. The apparatus can be a battery cell. The battery cell can include a plurality of electrodes having a first polarity and a plurality of electrode tabs. The plurality of electrode tabs can form an electrode stack tab. The battery cell can include a current collector having the first polarity. The battery cell can include the current collector pre-welded with the electrode stack tab via a plurality of joints. The battery cell can include the current collector welded with the electrode stack tab via a weld pool.

At least one aspect is directed to a system. The system can be an electric vehicle. The electric vehicle can include a battery pack including a battery cell. The battery cell can include a plurality of electrodes having a first polarity and a plurality of electrode tabs, the plurality of electrode tabs forming an electrode stack tab. The battery cell can include a current collector having the first polarity, the current collector pre-welded with the electrode stack tab via a plurality of joints and welded with the electrode stack tab via a weld pool.

At least one aspect is directed to an apparatus. The apparatus can be a battery cell. The battery cell can include a plurality of electrodes having a first polarity and a plurality of electrode tabs. The plurality of electrode tabs can form an electrode stack tab. The battery cell can include a current collector having the first polarity. The current collector can be pre-welded with the electrode stack tab via a plurality of joints. The current collector can be welded with the electrode stack tab via a weld pool.

At least one aspect is directed to an apparatus. The apparatus can be a battery cell. The battery cell can include a current collector and an electrode stack tab coupled with the current collector. The electrode stack tab can be coupled with the current collector by emitting, by a laser welding device for a first duration, a single pulse beam to pre-weld the electrode stack tab with the current collector. The electrode stack tab can be coupled with the current collector by emitting, by the laser welding device for a second duration, a continuous wave beam to weld the electrode stack tab with the current collector.

At least one aspect is directed to an electric vehicle. The electric vehicle can include a battery pack including a battery cell. The battery cell can include a current collector and an electrode stack tab coupled with the current collector. The electrode stack tab can be coupled with the current collector by emitting, by a laser welding device for a first duration, a first beam (e.g., a single pulse beam) to pre-weld the electrode stack tab with the current collector. The electrode stack tab can be coupled with the current collector by emitting, by the laser welding device for a second duration, a second beam (e.g., a continuous wave beam) to weld the electrode stack tab with the current collector.

At least one aspect is directed to a method of providing a battery cell. The battery cell can include a current collector and an electrode stack tab coupled with the current collector. The electrode stack tab can be coupled with the current collector by emitting, by a laser welding device for a first duration, a first beam (e.g., a single pulse beam or some other beam) to pre-weld the electrode stack tab with the current collector. The electrode stack tab can be coupled with the current collector by emitting, by the laser welding device for a second duration, a second beam (e.g., a continuous wave beam or some other beam) to weld the electrode stack tab with the current collector.

At least one aspect is directed to a method of providing a battery module or a battery pack. The battery module or the battery pack can include a battery cell and a current collector. The battery cell can include a terminal. The battery pack or the battery module can include the terminal of the battery cell pre-welded with the current collector via a plurality of joints and welded with the current collector via a weld pool.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example electrode stack having a tab coupled with a current collector, in accordance with some aspects.

FIG. 2 depicts an example tab coupled with a current collector, in accordance with some aspects.

FIG. 3 depicts an example tab coupled with a current collector, in accordance with some aspects.

FIG. 4 depict an example tab coupled with a current collector, in accordance with some aspects.

FIG. 5 depicts an example tab coupled with a current collector, in accordance with some aspects.

FIG. 6 depicts an example tab coupled with a current collector, in accordance with some aspects.

FIG. 7 depicts an example battery cell coupled with a current collector, in accordance with some aspects.

FIG. 8 depicts an example battery cell coupled with a current collector, in accordance with some aspects.

FIG. 9 is a flow chart of an example method of manufacturing a battery cell, in accordance with some aspects.

FIG. 10 depicts an example electric vehicle, in accordance with some aspects.

FIG. 11 depicts an example battery pack, in accordance with some aspects

FIG. 12 depicts an example battery module, in accordance with some aspects.

FIG. 13 depicts an example cross sectional view of a battery cell, in accordance with some aspects.

FIG. 14 depicts an example cross sectional view of a battery cell, in accordance with some aspects.

FIG. 15 depicts an example cross sectional view of a battery cell, in accordance with some aspects

FIG. 16 is a block diagram illustrating an architecture for a computer system that can be employed to implement elements of the systems and methods described and illustrated herein.

FIG. 17 is a flow chart of an example method of providing a battery cell, in accordance with some aspects.

FIG. 18 is a flow chart of an example method of providing a battery module or battery pack, in accordance with some aspects.

### DETAILED DESCRIPTION

Following below are more detailed descriptions of various concepts related to, and implementations of, methods, apparatuses, and systems of battery manufacture. The various concepts introduced above and discussed in greater detail below may be implemented in any of numerous ways.

The present disclosure is directed to systems and methods of manufacturing a battery cell. For example, the present disclosure is directed to systems and methods of mechanically and electrically coupling an electrode stack tab with a current collector or mechanically and electrically coupling a current collector of a battery module or battery pack with a terminal of one or more battery cells. For example, the electrode stack tab can be a stack of individual electrode tabs associated with a group of electrodes (e.g., a cathode electrode or an anode electrode) forming an electrode layer stack. The electrode tabs of the electrode stack can include a first polarity (e.g., a cathode polarity or an anode polarity). The current collector can be an electrically conductive member that is coupled with a terminal of a battery cell, a second electrode stack tab of a second electrode stack, or some other object or device. The current collector can have the first polarity. The current collector of the battery module or battery pack can be an electrically conductive member that is coupled with the terminal of one or more battery cells to electrically couple the battery cell(s) with another object (e.g., an electrical connector, another battery cell, an electrical switch, an electrical contactor, or some other object). The terminal of the battery cell and the current collector of the module or pack can include the same or similar polarity.

The disclosed solutions have a technical advantage of pre-welding and welding the electrode stack tab with the current collector or pre-welding the current collector of a battery module or battery pack with a terminal of one or more battery cells. For example, the disclosed solutions can include pre-welding the electrode stack tab with the current collector and welding the electrode stack tab with the current collector via a single laser welding device. Rather than pre-welding the electrode stack tab in a separate operation (e.g., an ultrasonic welding operation) to mechanically couple the individual electrode layers together, the disclosed solutions can include the laser welding device to pre-weld the electrode stack tab. For example, the laser welding device can include a laser element to emit a beam (e.g., a laser beam). The beam can be a single pulse beam (e.g., a short burst) or a continuous wave beam (e.g., a sustained beam), where the single pulse beam can include a first power, energy density, intensity, wavelength, pulse-width, or duration that can be the same as or different than a second power, energy density, intensity, wavelength, pulse-width, or duration of the continuous wave beam.

Systems and methods of the present technical solution can include the laser welding device to emit at least one first beam (e.g., a single pulse beam or some other beam) to pre-weld a first object (e.g., the electrode stack tab, a current collector, or some other object) with a second object (e.g., a current collector, a terminal of a battery cell, or some other object). For example, the laser welding device can emit multiple single pulse beams to create multiple joints between individual electrode tabs of the electrode stack tab and between the electrode stack tab and the current collector. Each joint can couple the individual electrode tabs of the electrode stack tab together to form a unitary (e.g., combined, unified, integrated) electrode stack tab. Each joint can join the electrode stack tab with the current collector such that the current collector and the electrode stack tab are mechanically coupled. The laser welding device can emit multiple single pulse beams to create multiple joints between a current collector and a terminal of one or more battery cells (e.g., to form a battery module or batter pack). The single pulse beam can cause a localized (e.g., thermally non-linear) reaction within the electrode stack tab (or the current collector, as the case may be) and the current collector (or the terminal of the battery cell, as the case may be) to prevent either object from substantially melting (e.g., ±90% melting). For example, the single pulse beam can provide intensive energy into the electrode stack tab and current collector over a short duration, where the short duration can reduce or minimize a heat-affected zone created by the beam. The laser welding device can emit the single pulse beam during a first operation. The same laser welding device can emit at least one second beam (e.g., a continuous wave beam or some other beam) during a second operation. For example, the continuous wave beam can weld the electrode stack tab with the current collector or can well a current collector with a terminal of a battery cell. For example, the continuous wave beam can at least partially melt the electrode stack tab and the current collector to create a weld pool. The laser welding device can emit the continuous wave beam in a pattern or in a particular manner to facilitate or promote welding of the electrode stack tab with the current collector.

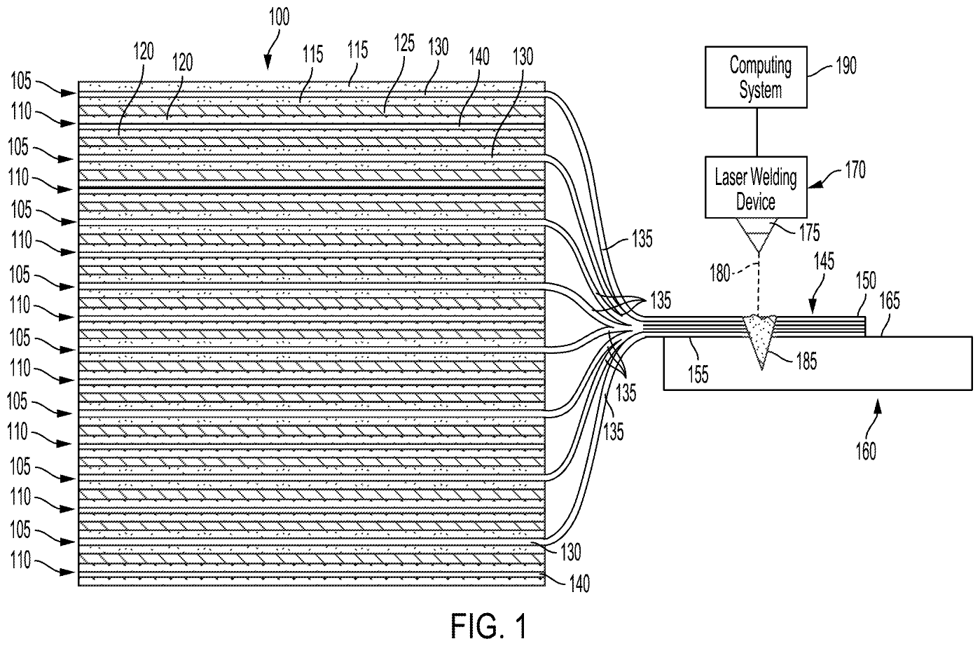

FIG. 1, among others, depicts an example electrode stack 100. The electrode stack 100 can include at least one first electrode 105 and at least one second electrode 110. For example, the first electrode 105 can be an anode electrode and the second electrode 110 can be a cathode electrode. Each of the first electrode 105 and the second electrode 110 can include a battery active material coupled with an electrically conductive foil layer. For example, the first electrode 105 can include at least one battery active material layer 115 and at least one electrically conductive foil layer 130. The first electrode 105 can include the battery active material layer 115 joined with the electrically conductive foil layer 130. For example, the electrode 105 can include a first battery active material layer 115 joined with (e.g., laminated to, coated on, adhered to) a first side of the electrically conductive foil layer 130 and a second battery active material layer 115 joined with (e.g., laminated to, coated on, adhered to) a second side of the electrically conductive foil layer 130. The battery active material layer 115 can be or include an anode active material. For example, the electrode 105 can be an anode electrode with a first battery active material layer 115 having an anode chemistry coated on (e.g., applied to) a top of the electrically conductive foil layer 130 and a second battery active material layer 115 having an anode chemistry coated on (e.g., applied to) a bottom of the electrically conductive foil layer 130. The electrically conductive foil 130 can be or include a copper material or some other material. The electrically conductive foil 130 can include a first polarity (e.g., an anode polarity).

The second electrode 110 can include a second battery active material layer 120 joined with a second electrically conductive foil layer 140. For example, the electrode 110 can include the battery active material layer 120 joined with (e.g., laminated to, coated on, adhered to) a first side of the second electrically conductive foil layer 140 and second battery active material layer 120 joined with (e.g., laminated to, coated on, adhered to) a second side of the electrically conductive foil layer 140. The battery active material layer 120 can be or include a cathode active material. For example, the electrode 110 can be an anode electrode with a first battery active material layer 120 having a cathode chemistry coated on (e.g., applied to) a top of the electrically conductive foil layer 140 and a second battery active material layer 120 having a cathode chemistry coated on (e.g., applied to) a bottom of the electrically conductive foil layer 140. The electrically conductive foil layer 140 can be or include an aluminum material or some other material. The electrically conductive foil 140 can include a second polarity (e.g., a cathode polarity). Although the discussion herein references the electrode 105 as being an anode electrode with a copper electrically conductive foil 130 and the electrode 105 as being a cathode electrode with an aluminum electrically conductive foil 140, it should be understood that the electrode 105 can be a cathode electrode or some other electrode and the electrode 110 can be an anode electrode or some other electrode.

The electrode stack 100 can include an electrolyte layer 125. The layer 125 can be positioned between adjacent electrode layers. For example, the layer 125 can be positioned between a first electrode layer 115 (e.g., an anode electrode layer 115) and a second electrode layer 120 (e.g., a cathode electrode layer 120). The layer 125 can be or include a solid electrolyte layer. The layer 125 can be or include a separator wetted by a liquid electrolyte. The layer 125 can be or include a polymeric material. The layer 125 can be or include a polymer separator. The layer 125 can be arranged between the anode layer 115 and the cathode layer 120 to separate the anode layer 115 and the cathode layer 120.

The electrically conductive foil layer 130 can include an electrode tab 135 to extend beyond (e.g., protrude from) the electrode 105. For example, the electrically conductive foil layer 130 can include the electrode tab 135, where the electrode tab 135 can be portion of the electrically conductive foil layer 130 that is not coated with (e.g., covered by, disposed between) one or more battery active material layers 115. The electrically conductive foil layer 130 can include the electrode tab 135 of the electrically conductive foil layer 130 that extends to at least one side of the electrode 105. The electrode tab 135 of the electrically conductive foil layer 130 can extend from a side of the electrode 105 to electrically couple the electrode 105 (e.g., the electrically conductive foil layer 130 of the electrode 105) with some other object, such as a current collector 160, at least one other electrode 105, or some other object.

The electrode tab 135 can be a portion of an electrically conductive foil layer 130 of the electrode 105 that extends from (e.g., protrudes from) at least one side of the electrode 105. The electrode tab 135 can be an uncoated portion of the electrically conductive foil layer 130. For example, the electrode tab 135 can be a portion of the foil layer 130 that is not coated with (e.g., laminated with, adhered to, joined with) a battery active material layer 115 of the electrode 105. The electrode tab 135 can be continuous with (e.g., integrated with, a part of) the electrically conductive foil layer 130 of the electrode 105. For example, the electrode tab 135 can be a remaining portion of the foil layer 130 that is not coated with battery active material layer 115 during production of the electrode 105 and after the uncoated portions of the foil layer 130 are notched to create the electrode tab 135 with other portions (e.g., a scrap portion, a discarded portion, an unused portion) of the foil layer 130 removed.

The electrically conductive foil layer 140 of the second electrode 110 can include a second electrode tab to extend beyond (e.g., protrude from) the electrode 110. For example, the electrically conductive foil layer 140 can include the second electrode tab, where the second electrode tab can be portion of the electrically conductive foil layer 140 that is not coated with (e.g., covered by, disposed between) one or more battery active material layers 120. The electrically conductive foil layer 140 can include the second electrode tab of the electrically conductive foil layer 140 that extends to at least one side of the electrode 110. The second electrode tab of the electrically conductive foil layer 140 can extend from a side of the electrode 110 to electrically couple the electrode 110 (e.g., the electrically conductive foil layer 140 of the electrode 110) with some other object, such as the current collector 160), at least one other electrode 110, or some other object.

The second electrode tab of the second electrode 110 can be a portion of an electrically conductive foil layer 140 of the electrode 110 that extends from (e.g., protrudes from) at least one side of the electrode 110. The second electrode tab can be an uncoated portion of the electrically conductive foil layer 140. For example, the second electrode tab can be a portion of the foil layer 140 that is not coated with (e.g., laminated with, adhered to, joined with) a battery active material layer 120 of the electrode 110. The second electrode tab can be continuous with (e.g., integrated with, a part of) the electrically conductive foil layer 140 of the electrode 110. For example, the second electrode tab can be a remaining portion of the foil layer 140 that is not coated with battery active material layer 120 during production of the electrode 110 and after the uncoated portions of the foil layer 140 are notched to create the second electrode tab with other portions (e.g., a scrap portion, a discarded portion, an unused portion) of the foil layer 140 removed.

The electrode stack 100 can include multiple electrode tabs 135 stacked together to form an electrode stack tab 145. For example, the electrode stack 100 can include the electrode stack tab 145 including multiple electrode tabs 135 associated with multiple electrodes 105, such as a first electrode tab 135 of a first electrode 105 stacked with a second electrode tab 135 of a second electrode 105. For example, the electrode stack 100 can include a first electrode 105 having a first electrode tab 135 and a second electrode 105 having a second electrode tab 135, where the first electrode tab 135 and the second electrode tab 135 are stacked adjacent to each other to form the electrode stack tab 145. The second electrode tab 135 can be stacked with (e.g., positioned against, abutting, contacting, positioned adjacent to) the first electrode tab 135 to form the electrode stack tab 145. Prior to any pre-welding or welding operation, the various electrode tabs 135 of the electrode stack tab 145 can be stacked together, but not mechanically coupled together. For example, an electrode tab 135 of the one electrode 105 can move relative to another electrode tab 135 of another electrode 105.

The electrodes 105 or electrode tabs 135 associated with the electrode stack tab 145 can include the same polarity (e.g., an anodic or cathodic polarity). For example and as depicted in FIG. 1, among others, the electrode stack 100 can include multiple anode electrodes 105 having anode electrode tabs 135 stacked together to form the electrode stack tab 145. Although not depicted in FIG. 1, the electrode stack 100 can include multiple cathode electrodes 110 having cathode electrode tabs stacked together to form an electrode stack tab. Each electrode tab 135 of the multiple electrodes 105 can be similar to or the same as other electrode tabs 135 of the other electrodes 105 in the electrode stack 100. For example, a first electrode tab 135 and a second electrode tab 135 can include the same or a similar material composition with both a first electrode 105 and a second electrode 105 being anode electrodes. For example, a first anode electrode 105 can include a first electrode tab 135 that can be or include a copper material. A second anode electrode 105 can include a second electrode tab 135 that can be or include a copper material.

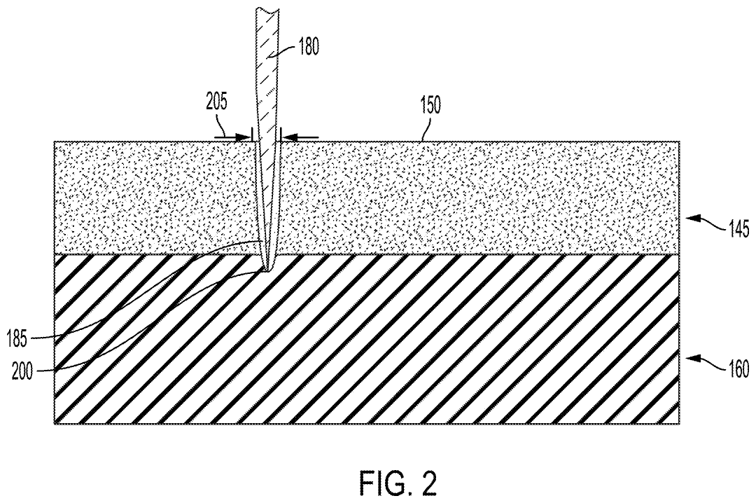

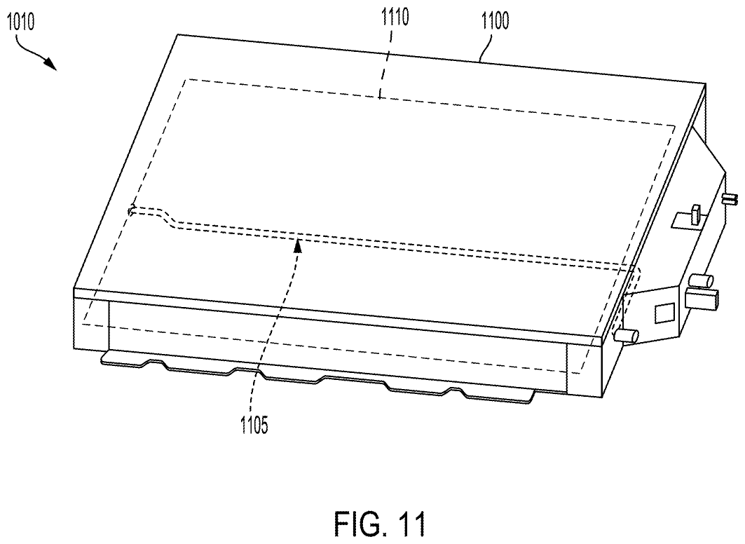

The electrode stack 100 can be coupled with a current collector. For example, the electrode stack 100 can be electrically coupled with the current collector 160. The electrode stack 100 can include the electrode stack tab 145 electrically coupled with the current collector 160. The current collector 160 can be an electrically conductive member within a housing of the battery cell (e.g., the housing 1300 shown in FIGS. 11-13 below) that can facilitate an electrical connection between the electrode stack 110 and some other object (e.g., a battery terminal or an electrode tab) located within or outside of the battery cell housing. The current collector 160 can be an electrically conductive member of an electrode stack (e.g., a jelly roll for a cylindrical battery cell or an electrode layer stack for a prismatic, pouch, or other cell). For example, the current collector 160 can be an electrode stack tab 145 of a second electrode stack 100. The current collector 160 can be coupled with at least one electrode 105 or at least one electrode 110 within the battery cell housing and at least one terminal (e.g., a battery cell terminal), where the terminal can be accessed outside of the housing of a battery cell. The current collector 160 can include a material composition that corresponds to a polarity of an electrode with which the current collector 160 is coupled. For example, the current collector 160 can be or include a copper material with the current collector 160 coupled with one or more anode electrodes 105 (e.g., an electrode 105 including an anode battery active material 115, a copper electrically conductive foil layer 130, and a copper electrode tab 135). The current collector 160 can be or include an aluminum material with the current collector 160 coupled with one or more cathode electrodes 110 (e.g., an electrode 110 including a cathode battery active material 120, an aluminum electrically conductive foil layer 140, and a corresponding aluminum electrode tab). Although FIGS. 1-6 depict at least one electrode 105 having the electrode tab 135 coupled with the current collector 160, it is understood that at least electrode 110 can be coupled with a current collector 160 in a similar or different manner.

As depicted in FIGS. 1-6, among others, the electrode stack tab 145 can be laser-welded with the current collector 160 to electrically couple the electrode stack tab 145 (and all individual electrode tab 130 comprising the electrode stack tab 145) with the current collector 160. For example, the electrode stack tab 145 can be laser welded to the current collector 160 by at least one laser welding device 170. The laser welding device 170 can be a green laser welding device (e.g., emitting light having a wavelength of 532 nm or light at some other wavelength), an infrared (IR) laser welding device (e.g., emitting light having a wavelength of 1064 nm or light at some other wavelength), or some other laser welding device. The laser welding device 170 can emit a laser to weld the electrode stack tab 145 to the current collector 160 to mechanically or electrically couple the electrode stack tab 145 with the current collector 160. As depicted in FIG. 1, among others, the laser welding device 170 can include a laser element 175 to emit at least one beam 180 (e.g., a laser beam). The laser element 175 can emit at least one beam 180 towards the electrode stack tab 145. For example, the laser element 175 can emit the beam 180 towards an upper surface of the electrode stack tab 145. The laser element 175 can emit the beam 180 directly perpendicular to the electrode stack tab 145 or at some angle (e.g., 45 degrees, 30 degrees, or some other angle) with respect the electrode stack tab 145.

The laser welding device 170 can emit the beam 180 towards an object (e.g., the electrode stack tab 145, a current collector, or some other object) with the object positioned on a fixture. For example, the object or objects to be welded via the laser welding device 170 can be positioned on a holding device, such as a fixture, clamp, mount, surface, or other holding device. The holding device can support the electrode stack 100, an electrode 105, 110 of the electrode stack 100, the electrode stack tab 145, an electrode tab 135 of the electrode stack tab 145, the current collector 160, or some other object. The holding device can support the object with the object positioned within an emittance zone of the laser welding device 170. For example, the holding device can support an object (e.g., the electrode stack tab 145) with the object positioned beneath the laser element 175 of the laser welding device 170 such that the beam 180 emitted from the laser welding device 170 can be emitted towards to the surface 150 of the electrode stack tab 145. The holding device can be stationary or movable. For example, the holding device can support an object in a stationary (e.g., fixed, static) position with the object positioned within an emittance zone of the laser welding device 170. The holding device can support an object with the holding device being movable with respect to the laser welding device 170. For example, the holding device can articulate, translate, rotate, tip, or otherwise move to alter a position of an object (e.g., the electrode stack tab 145, the current collector, a terminal of a battery cell, or some other object) with respect to the laser welding device 170. For example, object can be movable with respect to the laser welding device 170 or the laser element 175 such that the beam 180 can be emitted towards multiple locations (e.g., areas, regions, spots, positions) of the object.

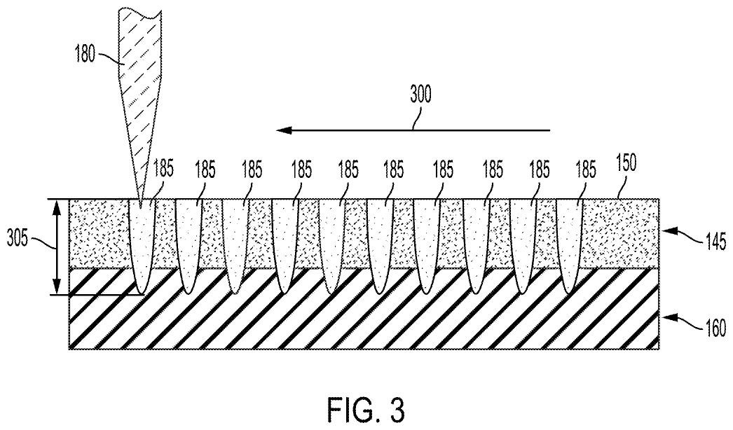

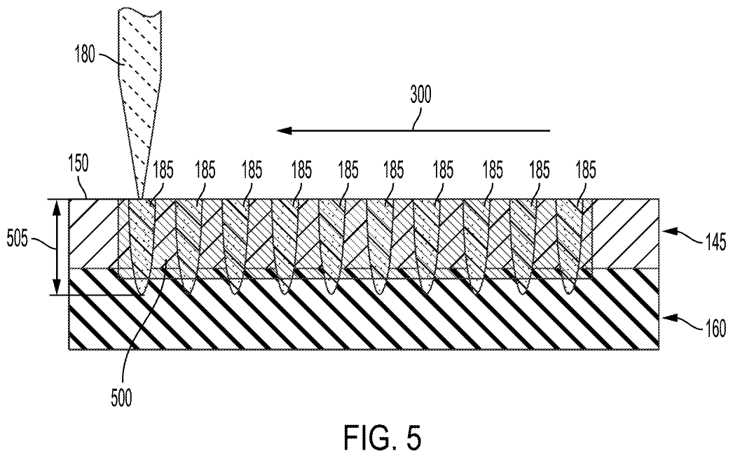

The laser welding device 170 or the laser element 175 of the laser welding device 170 can be movable or repositionable. For example, the laser welding device 170 or the laser element 175 can articulate, translate, rotate, tip, or otherwise move to alter the emittance zone of the laser welding device 170. The laser welding device 170 or the laser element 175 can be movable to alter a location towards which the beam 180 is emitted. The laser welding device 170 or the laser element 175 can be movable with respect to an object supported by the holding device (e.g., an electrode stack tab 145) such that the beam 180 can be emitted towards multiple locations. For example, the laser welding device 170 or the laser element 175 can be movable with respect to an electrode stack tab 145 such that the beam 180 can be emitted towards multiple locations (e.g., spots, areas, regions, positions) of the electrode stack tab 145. As depicted in FIGS. 3 and 5, among others, the beam 180 be emitted towards the surface 150 of the electrode stack tab 145 as the laser welding device 170, laser element 175, or beam 180 moves in along a path 300 (e.g., a line extending in a horizontal direction, a curvilinear path, a straight path, or some other line). The laser welding device 170 or laser element 175 can move along the path 300 or some other direction as the electrode stack tab 145 or another object (e.g., a current collector or some other object to be welded) remains stationary or as the electrode stack tab 145 or other object (e.g., current collector) moves.

The laser element 175 of the laser welding device 170 can emit the beam 180 as a single pulse laser beam, a continuous wave laser beam, some other laser beam, or some combination thereof. For example, the laser element 175 can emit the beam 180 as a first beam 180. The first beam 180 can be a single pulse laser that is emitted towards the electrode stack tab 145 for a relatively short duration (e.g., less than one second). The laser element 175 can emit the beam 180 as a single pulse laser towards a first location (e.g., a single point, a discrete region, or discrete area). For example, the first location can be a point, region, or area of the electrode stack tab 145 or some other object (e.g., a current collector). The beam 180 can be a single pulse laser that is emitted for a first duration and directed towards a single location of the electrode stack tab 145 or other object. The single location can be a location having dimensions substantially similar (e.g., ±75% similar) to a diameter of the single pulse beam 180. For example, the single location can be a relatively small area that is less than 10% of an area of the upper surface 150 of the electrode stack tab 145.

The laser element 175 of the laser welding device 170 can emit the beam 180 as a single pulse laser having a first diameter, a first power, a first energy density, and a first wavelength. The first diameter can be 100 μm-400 μm, greater than 400 μm, or less than 100 μm. For example, the first diameter can be 150 μm-300 μm or some other diameter. The first power or the first energy density can be 300 W-1800 W, greater than 1500 W, or less than 500 W. For example, the first power can be 500 W-1500 W or some other power or energy density. The single pulse beam 180 can include a first intensity that can be a function of the first power or first energy density and the first diameter or area of the beam 180. The single pulse beam 180 can include a first wavelength. The first wavelength can be an infrared wavelength, a green wavelength, or some other wavelength. For example, the single pulse beam 180 can be an infrared laser having a wavelength of 780 nm to 1 mm or some other wavelength.

The laser welding device 170 can include the laser element 175 to emit the beam 180 as a single pulse laser for a first duration. For example, the single pulse beam 180 can be a single pulse (e.g., burst, shot, emittance) having the first duration that is relatively short (e.g., as compared to a continuous wave laser or some other laser). The pulse-width of the single pulse beam 180 emitted by the laser welding device 170 can be the first duration. The laser element 175 can emit the single pulse beam 180 towards the surface 150 of the electrode stack tab 145 for the first duration and then immediately or substantially immediately (e.g., within milliseconds) cease emitting the beam 180 towards the surface 150. For example, the first duration can be less than 100 ms, 20-100 ms, less than 20 ms, or some other duration.

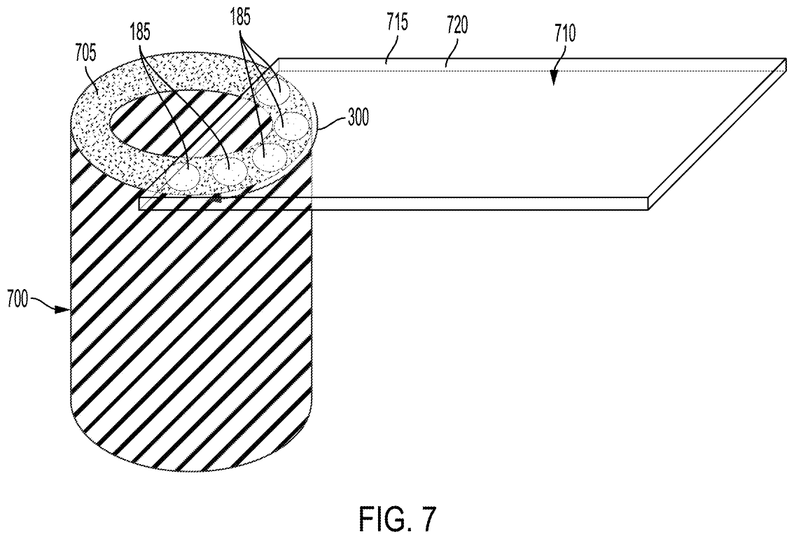

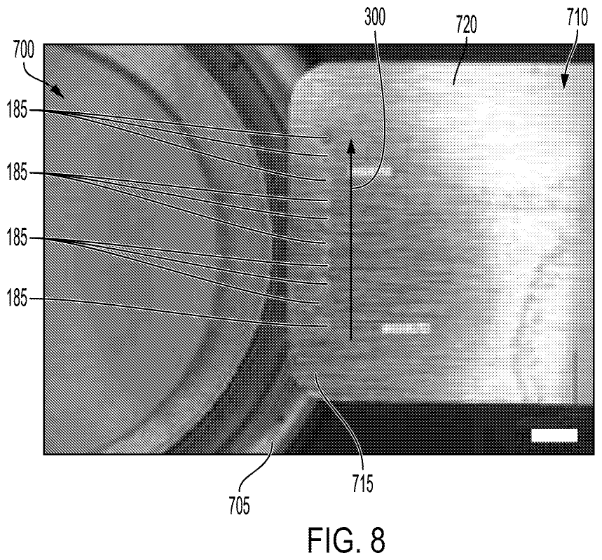

The laser welding device 170 can emit at least one single pulse beam 180 towards a surface of a member (e.g., the electrode stack tab 145, a current collector of a battery module or battery pack, a terminal of a battery cell, or some other member) to create at least one joint 185. The surface can be a weld interface (e.g., an interface of one or more components to be welded). For example, the laser welding device 170 can emit a single pulse beam 180 towards the surface 150 of the electrode stack tab 145 to create at least one joint 185. The joint 185 can be a welded interface that joins (e.g., mechanically couples, welds, fuses, or otherwise mates) the electrode stack tab 145 with the current collector 160. For example, the electrode stack tab 145 (e.g., the electrode tabs 135 of the electrode stack tab 145) can be physically joined with the current collector 160 such that the current collector 160 cannot be separated from the electrode stack tab 145 without damaging or destroying one of the current collector 160 and the electrode stack tab 145. The joint 185 can be a welded joint that joins (e.g., mechanically couples, welds, fuses, or otherwise mates) the electrode tabs 135 of the electrode stack 145 together. For example, the joint 185 can join the electrode tabs 135 of the electrode stack 145 together such that one or more individual electrode tabs 135 or a group of electrode tabs 135 cannot be removed (e.g., separated, pulled apart, or otherwise isolated) from another electrode tab 135. For example, the laser welding device 170 can emit the single pulse beam 180 to the electrode stack tab 145 to cause the electrode tabs 135 to form a unitary or joined structure of the electrode stack tab 145. For example, the electrode stack tab 145 can be a single member having multiple electrode tabs 135 joined (e.g., coupled, welded, mechanically bound) together. As depicted in FIGS. 7 and 8, among others, the laser welding device 170 can emit at least one single pulse beam 180 towards a current collector to create at least one joint 185 at a weld interface, such as an interface of the current collector and another member, such as the terminal of a battery cell, for example.

The joint 185 can include a melding, melting, combining, or blending of the current collector 160 with the electrode stack tab 145 or with multiple electrode tabs 135 of the electrode stack tab 145. For example, the single pulse beam 180 emitted by the laser element 175 of the laser welding device 170 can cause a portion of the electrode stack tab 145 and a portion of the current collector 160 to melt and combine to form the joint 185. The beam 180 can include sufficient energy (e.g., power, energy density, intensity) to cause at least a portion of the electrode stack tab 145 and at least a portion of the current collector 160 to melt, meld, combine, or weld with the electrode stack tab 145 against the surface 165 of the current collector 160. For example, a lower surface of the electrode stack tab 145 can be positioned against (e.g., abutting, contacting, or touching) the surface 165 or some other surface of the current collector 160. A portion of the surface 165 of the current collector 160 and the lower surface of the electrode stack tab 145 that is contacting (e.g., abutting, touching, positioned against) the surface 165 can melt, meld, weld, or combine to form the joint 185. For example, the joint 185 can extend through each of the electrode tabs 135 of the electrode stack tab 145 and at least a portion of the current collector 160 to form the joint 185.

As depicted in FIGS. 1-3, among others, the beam 180 can penetrate the electrode stack tab 145 and a portion of the current collector 160 to create the joint 185 that joins (e.g., couples, binds, welds) the electrode stack tab 145 with the current collector 160. For example, the joint 185 can include a point 200 that extends beneath the surface 165 of the current collector 160 (e.g., into the current collector 160). The joint 185 can include the point 200 located a depth 305 from the surface 150 of the electrode stack tab 145. For example, the point 200 can extend the depth 305 through an entire thickness of the electrode stack tab 145 and a portion of a thickness of the current collector 160, as depicted in FIG. 3, among others. The point 200 can be a melt (e.g., an area, region, or zone that has been at least partially melted) that can include a material characteristic or property that differs from an un-melted area, region, or zone of the current collector 160. For example, the joint 185 or the point 200 can be a melt having a particular material grain, whereas a remainder of the current collector 160 can include a different material grain. For example, the joint 185 can include visibly different material characteristics (e.g., color, hue, grain, or some other characteristic) than the current collector 160. The point 200 may be visibly different than the current collector 160 with the electrode stack tab 145 and the current collector 160 sectioned (e.g., cut) for inspection, for example. A top of the joint 185 (e.g., a portion of the joint visible from the surface 150) can include visibly different material characteristics than the electrode stack tab 145. For example, the top of the joint 185 can be or include a melt having a material grain or some other property that differs from a material grain or some other property of the electrode stack tab 145. The joint 185 can have a top including a surface morphology that differs from a surface morphology of the electrode stack tab 145, for example. The joint 185 can extend from the surface 150 of the electrode stack tab 145 past the surface 165 of the current collector 160 and into the current collector 160 to join the electrode stack tab 145 with the current collector 160. The joint 185 can include a width 205. The width 205 can be substantially less than a width of the electrode stack tab 145 or a width of the current collector 160. For example, the width 205 can be approximately equal to (e.g., ±95%) the first diameter of the single pulse beam 180. The single pulse beam 180 can create at least one joint 185, where each joint 185 can include a width 205 that is substantially less than (e.g., <5%) a width of the electrode stack tab 145.

The laser welding device 170 can include the laser element 175 to emit the beam 180 toward a surface of a first member (e.g., the electrode stack tab 145, a current collector of a battery module or battery pack, a terminal of a battery cell, or some other member) to couple the member with another member (e.g., the current collector 160, a terminal of a battery cell, or some other member) without providing substantial heat to the first member or the second member. For example, the laser welding device 170 can include the laser element 175 to emit the beam 180 toward the surface 150 of the electrode stack tab 145 to couple the electrode stack tab 145 with the current collector 160 without providing substantial heat to the electrode stack tab 145 or the current collector 160. For example, the single pulse beam 180 can be emitted by the laser element 175 for the first duration, where the first duration is relatively short to prevent or substantially reduce (e.g., reduce ±90% of) melting of the electrode stack tab 145, various of the electrode tabs 135 of the electrode stack tabs 145, or the current collector 160. The single pulse beam 180 can cause a localized (e.g., thermally non-linear) reaction within the electrode stack tab 145 and the current collector 160 to prevent each from substantially melting (e.g., ±90% melting). The single pulse beam 180 can be emitted by the laser element 175 for the first duration to minimize or reduce an area (e.g., a surface area, volume, or other area) of the electrode stack tab 145 that is melded or thermally affected by the single pulse beam 180.

The laser element 175 of the laser welding device 170 can emit multiple single pulses beams 180 towards a surface of a member, such as the electrode stack tab 145, a current collector, a terminal of a battery cell, or some other member. For example, the laser element 175 of the laser welding device 170 can emit multiple single pulses beams 180 towards the surface 150 of the electrode stack tab 145. For example, the laser element 175 can emit multiple single pulse beams 180 toward the surface 150 of the electrode stack tab 145 to create multiple joints 185. As depicted in FIG. 3, among others, the beam 180 can form multiple joints 185 along a dimension (e.g., width, length, or some other dimension) of the electrode stack tab 145. For example, the laser element 175 can emit the single pulse beam 180 along a length of the electrode stack tab 145 to create a series of joints 185. Each joint 185 can mechanically and electrically couple the electrode stack tab 145 with the current collector 160. For example, each joint 185 can include the width 205 to couple the electrode stack tab 145 with the current collector 160 in multiple spots. As noted above, each joint 185 can include the width 205 that is substantially less than (e.g., <5% of) a width of the electrode stack tab 145 or current collector 160. The multiple joints 185 can collectively couple the electrode stack tab 145 with the current collector 160 at a series of points, where each point can include the width 205, and where the collective width of the multiple joints 185 can be substantially less than (e.g., <50%) of a width of the electrode stack tab 145 or the current collector 160. For example, the multiple joints 185 can be relatively small spot welds that mechanically couple the electrode stack tab 145 with the current collector 160 without creating a weld pool to weld a substantial portion (e.g., 70%) of the electrode stack tab 145 with the current collector 160.

The laser welding device 170 can include the laser element 175 to emit multiple single pulse beams 180 to the surface 150 of the electrode stack tab 145 to pre-weld the electrode tabs 135 of the electrode stack tab 145 together. For example, rather than ultrasonically welding the electrode tabs 135 together to form the electrode stack tab 145, the laser welding device 170 can include the laser element 175 to emit at least one single pulse beam 180 towards the surface 150 of the electrode stack tab 145 to join (e.g., couple, bond, weld) each of the electrode tabs 135 together (e.g., to an adjacent electrode tab 135) to create a unitary electrode stack tab 145. For example, the electrode tabs 135 of the electrode stack tab 145 can be coupled together and prevented from separating after pre-welding the electrode tabs 135 with the single pulse beam 180 emitted by the laser element 175. The electrode tabs 135 of the electrode stack tab 145 can be coupled together at each of the joints 185 of created by the single pulse beam 180. For example, the electrode tabs 135 of the electrode stack tab 145 can be welded, joined, coupled, mated, or otherwise prevented from separating at each of the joints 185 created by multiple single pulse beams 180 emitted from the laser welding device 170. The electrode tabs 135 of the electrode stack tab 145 can be pre-welded together with the multiple joints 185 collectively or individually preventing the electrode tabs 135 of the electrode stack tab 145 from separating.

The laser welding device 170 can include the laser element 175 to emit multiple single pulse beams 180 toward a surface of a member (e.g., the electrode stack tab 145, a current collector of a battery module or a battery pack, a terminal of a battery cell, or some other member) to pre-weld the member with a current collector. For example, the laser welding device 170 can include the laser element 175 to emit multiple single pulse beams 180 to the surface 150 of the electrode stack tab 145 to pre-weld the electrode stack tab 145 with the current collector 160. For example, the single pulse beam 180 can cause the individual electrode tabs 135 of the electrode stack tab 145 to be mechanically coupled together and cause the electrode stack tab 145 to be mechanically coupled with the current collector 160. As depicted in FIGS. 1-6, the electrode stack tab 145 can be positioned against (e.g., contacting, supported on, adjacent to) the current collector 160. The single pulse beam 180 can include a power, energy density, or intensity sufficient to create the joint 185 that penetrates the current collector 160 (e.g., goes beyond the surface 165 of the current collector 160). The electrode stack tab 145 can be pre-welded to the electrode stack tab 145 with the current collector 160 such that the current collector 160 cannot be separated from the electrode stack tab 145. For example, the electrode stack tab 145 can be pre-welded to the current collector 160 via at least one single pulse beam 180 such that a position of the electrode stack tab 145 cannot change relative to the current collector 160.

The laser welding device 170 can emit the single pulse beam 180 towards a member (e.g., the electrode stack tab 145, a terminal of a battery cell, or some other member) to reduce or substantially eliminate (e.g., eliminate ±98%) of space between adjacent electrode tabs 135. For example, prior to a pre-welding operation, the electrode stack tab 145 can include multiple electrode tabs 135 that are stacked together but uncoupled such that an individual electrode tab 135 can be moved (e.g., separated from) another electrode tab 135. Because the electrode tabs 135 are not mechanically coupled together and can move with respect to each other, a space or gap can exist between adjacent electrode tabs 135 of the electrode stack tab 145. Furthermore, an individual electrode tab 135 or a group of electrode tabs 135 can be inadvertently moved, repositioned, misaligned, folded, damaged, or otherwise affected with the electrode tab 135 not mechanically coupled with adjacent electrode tabs 135. Misalignment, damage, or inadvertent repositioning of an electrode tab 135 can adversely affect the operation of a battery cell (e.g., the battery cell 700, as discussed below and shown in FIG. 8) including the electrode stack 100. The laser welding device 170 can emit the single pulse beam 180 towards the electrode stack tab 145 to pre-weld (e.g., couple, join, bond, weld, secure) the individual electrode tabs 135 together to form the electrode stack tab 145, where pre-welding the electrode tabs 135 to form the electrode stack tab 145 can reduce or substantially eliminate space between adjacent electrode tabs 135. For example, an air gap or space between adjacent electrode tabs 135 can be eliminated with the electrode tabs 135 pre-welded together via at least one joint 185 created by at least one single pulse beam 180. An air gap or space between adjacent electrode tabs 135 can be eliminated with the electrode tabs 135 pre-welded together via multiple joints 185 with each joint created by a single pulse beam 180.

The laser welding device 170 can include the laser element 175 to emit the beam 180 as at least one second beam 180. The second beam 180 can be a continuous wave laser beam 180. For example, the laser element 175 can emit the beam 180 as a continuous wave laser that is emitted towards a member (e.g., the electrode stack tab 145, a current collector of a battery module or a battery pack, a terminal of a battery cell, or some other member) for a relatively long duration (e.g., greater than one second). The laser element 175 can emit the beam 180 as a continuous wave laser towards a second location (e.g., an area, a region, or zone) of the surface 150 of the electrode stack tab 145. For example, the second location can be a location having dimensions substantially larger (e.g., multiple times larger) than a diameter of the continuous wave beam 180. The second location can be an area of the surface 150 of the electrode stack tab 145 that is less than 10%, 10-30%, 30-50%, 50-80%, greater than 80% of a surface area of the surface 150. For example, rather than being a single discrete spot or a series of discrete spots, the second location a broader area or zone of the surface 150 of the electrode stack tab 145.

The laser element 175 of the laser welding device 170 can emit the beam 180 as a continuous wave laser having a second diameter, a second power, a second energy density, and a second wavelength. The second diameter can be the same as or different than the first diameter of the single pulse beam 180. For example, the second diameter can be 100 μm-400 μm, greater than 400 μm, or less than 100 μm. The second diameter can be 150 μm-300 μm or some other diameter. The second power or second energy density can be 150 W-1200 W, greater than 1200 W, or less than 150. For example, the second power can be 300 W-1000 W or some other power or energy density. The continuous wave beam 180 can include a second intensity that can be a function of the second power or second energy density and the second diameter or area of the beam 180. The continuous wave beam 180 can include a second wavelength. The second wavelength can the same as or different than the first wavelength. The second wavelength can be an infrared wavelength, a green wavelength, or some other wavelength. For example, the continuous wave beam 180 can be an infrared laser having a wavelength of 780 nm to 1 mm or some other wavelength.

The laser welding device 170 can include the laser element 175 to emit the beam 180 as a continuous wave laser for a second duration. For example, the continuous wave beam 180 can be a laser that is emitted continuously for the second duration that is relatively long (e.g., as compared to the first duration of the single pulse beam 180 or some other laser). The laser element 175 can emit the continuous wave beam 180 towards the surface 150 of the electrode stack tab 145 for the second duration and then immediately or substantially immediately (e.g., within milliseconds) cease emitting the beam 180 towards the surface 150. For example, the second duration can be less than one second, 1-2 seconds, or greater than two seconds. The laser element 175 can continuously emit the continuous wave beam 180 for the entirety of the second duration. For example, the beam 180 can be emitted towards the surface 150 of the electrode stack tab 145 for the entire second duration as the beam 180 moves along the surface 150.

The laser welding device 170 can include the laser element 175 emit the continuous wave beam 180 along the surface 150 of the electrode stack tab 145 at a second speed. As depicted in FIG. 5, among others, the laser welding device 170 can emit the continuous wave beam 180 towards the surface 150 of the electrode stack tab 145 as the beam 180 moves along the path 300 (e.g., a line extending in a horizontal direction, a curvilinear path, a straight line, or some other line), where the beam 180 can move along the path 300 at the second speed. The second speed can be less than 100 mm/s, 100-1000 mm/s, or greater than 800 mm/s. For example, the second speed can be 200-800 mm/s. The laser welding device 170, the laser element 175, or the electrode stack tab 145 and current collector 160 can move to cause the beam 180 to move at the second speed. For example, the laser welding device 170 or the laser element 175 can articulate, translate, rotate, or otherwise move relative to the electrode stack tab 145 to cause the beam 180 to move along the surface 150 of the electrode stack tab 145. The electrode stack tab 145 and the current collector 160 can move relative to the laser welding device 170 or laser element 175 to cause the beam 180 to move along the surface 150 of the electrode stack tab 145.

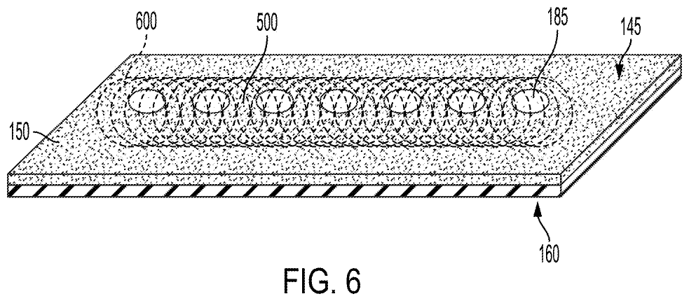

The laser welding device 170 can emit the continuous wave beam 180 towards the surface 150 of the electrode stack tab 145 to create at least one weld pool 500. As depicted in FIG. 5, among others, the continuous wave beam 180 can be emitted towards the surface 150 for the second duration to provide heat to the electrode stack tab 145 (e.g., to the multiple electrode tabs 130) and to the current collector 160 to at least partially melt the current collector 160 and the electrode stack tab 145. As depicted in FIGS. 5 and 6, among others, the weld pool 500 can be created on the joint 185. For example, the weld pool 500 can be created over the same first location(s) (e.g., spot, point, discrete area) in which the laser welding device 170 previously emitted at least one single pulse beam 180 to create at least one joint 185. The weld pool 500 can include a depth 505 that is less than the depth 305 of the joint 185. For example, the point 200 of the joint 185 can extend past a lower (e.g., inner-most) edge of the weld pool 500. The weld pool 500 can include a depth 505 that is greater than the depth 305 of the joint 185. For example, the point 200 of the joint 185 can extend to a point above a lower (e.g., inner-most) edge of the weld pool 500.

The melting of the electrode stack tab 145 and the current collector 160 can cause the electrode stack tab 145 and the current collector to be fused, joined, welded, coupled, or otherwise bonded such that the electrode stack tab 145 and the current collector 160 cannot be separated. The weld pool 500 can be a molten pool created by at least partially melting the electrode stack tab 145 and the current collector 160. For example, the continuous wave beam 180 can include sufficient energy, power, energy density, or intensity to impart thermal energy to the electrode stack tab 145 and the current collector 160 to cause at least a portion of the electrode stack tab 145 and at least a portion of the current collector 160 to melt. The continuous wave beam 180 can be cause a linear thermal reaction within the electrode stack tab 145 and the current collector 160 to cause each to at least partially melt. The current collector 160 and the electrode stack tab 145 can become fused, joined, or welded together as the current collector 160 and the electrode stack tab 145 are melted. For example, the electrode stack tab 145 can be physically joined with the current collector 160 such that the current collector 160 cannot be separated from the electrode stack tab 145 without damaging or destroying one of the current collector 160 and the electrode stack tab 145. The weld pool 500 can subsequently cool and harden to create a welded joint that electrically and mechanically couples the electrode stack tab 145 and each individual electrode tab 135 therein with the current collector 160.

The laser welding device 170 can include the laser element 175 to emit the continuous wave beam 180 towards the surface 150 of the electrode stack tab 145 with the beam 180 moving in at least one pattern 600. As depicted in FIG. 6, among others, the laser welding device 170 or the laser element 175 can emit the continuous wave beam 180 towards the surface 150 of the electrode stack tab 145 as the beam 180 moves relative to the surface 150 in a pattern, along a path, or in some dynamic manner. For example, the continuous wave beam 180 can move along a circular path, a figure eight path, a zig-zag path, a sinusoidal path, or some other path to create the pattern 600. The continuous wave beam 180 can be directed towards a point on the surface 150 multiple times (e.g., twice, three times, more than three times) with the beam 180 forming the pattern 600. For example, the continuous wave beam 180 can move continuously within a region or area of the surface 150 of the electrode stack tab 145 to form the weld pool 500 by moving according to the pattern 600 or some other pattern. The movement of the continuous wave beam 180 according to the pattern 600 or some other pattern can be optimized to create the weld pool 500 according to specific parameters. For example, the movement of the continuous wave beam 180 according to the pattern 600 can create the weld pool 500 in less time than a continuous wave laser moving according to some other pattern. The movement of the continuous wave beam 180 according to the pattern 600 can create the weld pool 500 having an even or substantially even (e.g., ±50% even) thermal distribution or having some other thermal characteristic (e.g., a particular temperature). The movement of the continuous wave beam 180 according to the pattern 600 can facilitate the welding of the current collector 160 with the electrode stack tab 145.

The laser welding device 170 can pre-weld the electrode stack tab 145 with the current collector 160 and the laser welding device can weld the electrode stack tab 145 with the current collector 160. Pre-welding the electrode stack tab 145 with the current collector 160 can be the same as or different than welding the electrode stack tab 145 with the current collector 160. For example, the electrode stack tab 145 can be pre-welded with the current collector 160 with the electrode stack tab 145 coupled with the current collector 160 via at least one discrete joint (e.g., the joint 185), rather than a single weld pool (e.g., the weld pool 500). A pre-welding operation can include emitting, via the laser welding device 170, one or more single pulse beams 180 to create multiple joints 185 to join the electrode stack tab 145 with the current collector 160 or to join the electrode tabs 135 of the electrode stack tab 145 together. A pre-welding operation can eliminate or reduce a space or gap between adjacent electrode tabs 135 of the electrode stack tab 145 via one or more joints 185. The pre-welding operation can create a localized (e.g., non-linear thermal) reaction within the electrode stack tab 145 and the current collector 160 to prevent or reduce melting of the electrode stack tab 145 or the current collector 160. The electrode stack tab 145 can be welded with the current collector 160 with the electrode stack tab 145 coupled with the current collector 160 via at least one weld pool (e.g., the weld pool 500) rather than multiple discrete joints (e.g., the joint 185), for example. A welding operation can include emitting, by the laser welding device 170, one or more continuous wave beams 180 to create a weld pool. The weld pool can melt, meld, combine, or weld the electrode stack tab 145 with the current collector 160 such that the electrode stack tab 145 and the current collector 160 can be combined (e.g., a unitary or integrated structure).

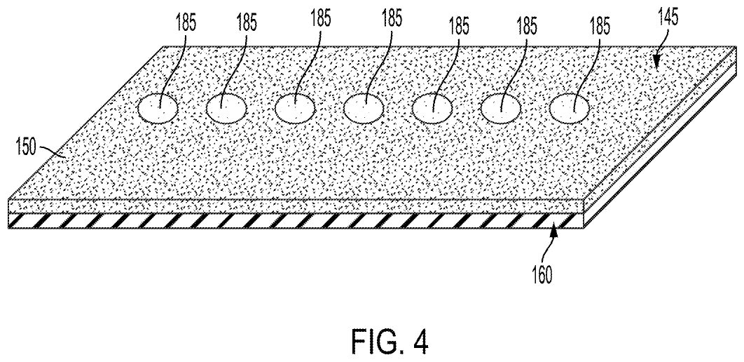

The laser welding device 170 can include the laser element 175 to emit a first beam 180 and a second beam 180. For example, the first beam 180 can be at least one single pulse beam 180. The second beam 180 can be a continuous wave beam 180. For example, the laser welding device 170 can emit a single pulse beam 180 towards the electrode stack tab 145 during a first laser welding operation and then emit a continuous wave beam 180 towards the same electrode stack tab 145 during a second laser welding operation. For example, the laser welding device 170 can emit at least one single pulse beam 180 to pre-weld the electrode tabs 135 of the electrode stack tab 145 together. The laser welding device 170 can emit the at least one single pulse beam 180 towards the electrode stack tab 145 to pre-weld the electrode stack tab 145 with the current collector 160. For example, as depicted in FIGS. 3-4, the laser welding device 170 can emit multiple single pulse beams 180 to create multiple joints 185, where the multiple joints 185 can pre-weld the electrode tabs 135 together and pre-weld the electrode stack tab 145 with the current collector 160 during the first laser welding operation. Subsequently, during the second laser welding operation, the laser welding device 170 can emit a continuous wave beam 180 to weld the electrode stack tab 145 with the current collector 160. For example, the laser welding device 170 can emit the continuous wave beam 180 to melt at least a portion of the electrode stack tab 145 and the current collector 160 to create a weld pool 500. The weld pool 500 can cause the current collector 160 and the electrode stack tab 145 to be welded, joined, coupled, or mated. The laser welding device 170 can emit the continuous wave beam 180 towards the surface 150 of the electrode stack tab 145 according to a pattern, such as the pattern 600 or some other pattern.

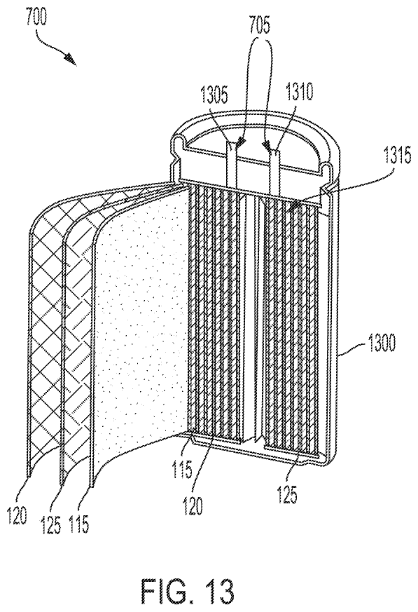

As depicted in FIGS. 7 and 8, among others, a current collector 710 can be welded with a battery cell 700. For example, the laser welding device 170 can weld the current collector 710 with at least one terminal 705 of the battery cell 700 to electrically or mechanically couple the current collector 710 with the battery cell 700. The battery cell 700 can include the terminal 705. For example, the battery cell 700 can include a first terminal 705 having a first polarity (e.g., a positive polarity) and a second terminal 705 having a second polarity (e.g., a negative polarity). The terminal 705 can exposed on the outside of the battery cell 700 such that the terminal is accessible and available for electrical connection with another object (e.g., the current collector 710). The terminal 705 can be electrically coupled with at least one electrode within an interior of the battery cell 705. For example, the battery cell 700 can include the electrode stack 100 having multiple electrodes 105 and multiple electrodes 110. The battery cell 700 can include the electrode stack tab 145 including multiple electrode tabs 135 coupled together. The battery cell 700 can include the current collector 160. For example, the current collector 160 can be coupled with the electrode stack tab 145. The current collector 160 can be pre-welded with the electrode stack tab 145 and welded with the electrode stack tab 145 according to two laser welding operations. For example, the current collector 160 can be pre-welded with the electrode stack tab 145 by at least one single pulse beam 180 emitted from a laser welding device 170, the single pulse beam 180 to create the joint 185 between the electrode stack tab 145 and the current collector 160. The current collector 160 can be welded with the electrode stack tab 145 by at least one continuous wave beam 180 emitted by the laser welding device 170 to create a weld pool. The current collector can be coupled with the terminal 705 of the battery cell 700. For example, the current collector 160 can be electrically coupled with a positive terminal 705 of (e.g., a button, boss, protrusion, or projection) of the battery cell 700 with the electrode stack tab 145, the current collector 160, and the positive terminal 705 each having a positive (e.g., anodic) polarity. The current collector 160 can be electrically coupled with a negative terminal 705 (e.g., a rim, surface, edge, lip, circumference, tab) of the battery cell 700 with the electrode stack tab 145, the current collector 160, and the negative terminal 705 each having a negative (e.g., cathodic) polarity. The battery cell 700 have a variety of form factors, shapes, or sizes. For example, battery cells 700 can have a cylindrical, rectangular, square, cubic, flat, pouch, elongated or prismatic form factor. As depicted in FIG. 13, for example, the battery cell 700 can be cylindrical, as depicted in FIGS. 13-15 and discussed below. The battery cell 700 can be or include at least one lithium-ion battery cell or at least one battery cell having another chemistry (e.g., a solid-state battery cell, a lead acid battery cell, or some other battery cell).

The current collector 710 can be or include an electrically conductive member. For example, the current collector 710 can comprise an electrically conductive material to facilitate the electrical coupling of multiple components (e.g., multiple batteries, a battery and an electrical connector, or between two other components). The current collector 710 can be a current collector for a battery pack of a battery module. For example, the current collector 710 can be a current collector for a battery module of an electric vehicle and can be configured to electrically couple multiple battery cells (e.g., multiple battery cells 700) together in a parallel configuration, a series configuration, or some combination thereof. The current collector 710 can include a surface 715. The current collector 710 can include at least one tab 720 (e.g., projection, extension, finger, prong, member, or other area) to couple with the battery cell 700. For example, the tab 720 of the current collector 710 can extend from a body (e.g., primary region, main bus, or other area) of the current collector 710 to couple with the terminal 705 of the battery cell 700. The current collector 710 can include multiple tabs 720. One or more of the multiple tabs 720 can correspond with a battery cell 700. For example, the current collector 710 can include multiple tabs 720, with each one corresponding to (e.g., coupled with or configured to be coupled with) one battery cell 700. The surface 715 of the current collector 710 can be visible or accessible with the current collector 710 (e.g., the tab 720 of the current collector 710) coupled with or prepared to be coupled with the terminal 705 of the battery cell 700.

The laser welding device 170 can include the laser element 175 to emit a first beam 180 and a second beam 180. For example, the first beam 180 can be at least one single pulse beam 180. The second beam 180 can be a continuous wave beam 180. For example, the laser welding device 170 can emit a single pulse beam 180 towards the surface 715 of the current collector 710 during a first laser welding operation and then emit a continuous wave beam 180 towards the same surface 715 of the current collector 710 during a second laser welding operation. For example, the laser welding device 170 can emit at least one single pulse beam 180 to pre-weld the current collector 710 with the terminal 705 of the battery cell 700. For example, the laser welding device 170 can emit multiple single pulse beams 180 to create multiple joints 185, where the multiple joints 185 can pre-weld the current collector 710 with the terminal 705 of the battery cell 700 during the first laser welding operation. Subsequently, during the second laser welding operation, the laser welding device 170 can emit a continuous wave beam 180 to weld the current collector 710 with the terminal 705 of the battery cell 700. For example, the laser welding device 170 can emit the continuous wave beam 180 to melt at least a portion of the current collector 710 and the terminal 705 to create a weld pool (e.g., the weld pool 500). The weld pool can cause the current collector 710 and the terminal 705 of the battery cell 700 to be welded, joined, coupled, melded, bonded, or mated, both mechanically and electrically. The laser welding device 170 can emit the continuous wave beam 180 towards the surface 715 of the electrode stack tab 145 according to a pattern, such as the pattern 600 or some other pattern.

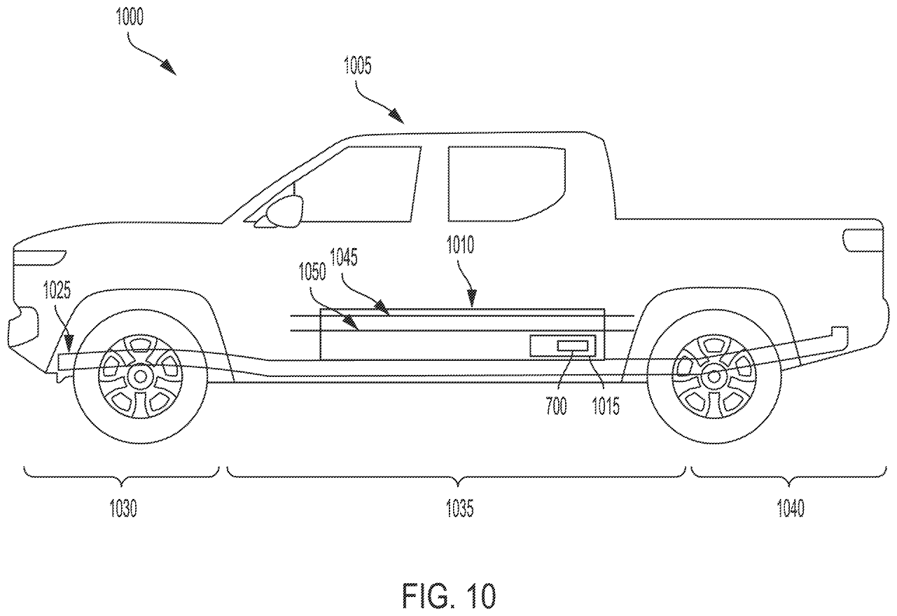

The laser welding device 170 can the current collector 710 to multiple battery cells 700. For example, the current collector 710 can include multiple tabs (e.g., protrusions, extensions, prongs, or other members), with each member corresponding to one or more battery cells 700. Each tab can be electrically coupled with the current collector 710 (e.g., in series or in parallel configuration). Each tab can be mechanically and electrically coupled with one or more battery cells 700 (e.g., via a terminal 705 of a battery cell 700) by the laser welding device 170. For example, the laser welding device 170 can pre-weld a battery cell 700 with a tab of the current collector 710 in a first welding operation that uses one or more single pulse beams 180 to create one or more joints 185 between the tab 720 of the current collector 710 and the terminal 705 of the corresponding battery cell 700. The laser welding device 170 can weld the tab of the current collector 710 with the corresponding battery cell 700 in a second, subsequent welding operation that uses a continuous wave beam 180 to create a weld pool (e.g., the weld pool 500) with the tab of the current collector 710 and the terminal 705 of the battery cell to join, meld, couple, or bond the tab of the current collector 710 with the terminal 705. The first and second welding operations can be repeated for multiple tabs of the current collector 710 to create a mechanical and electrical coupling between the current collector 710 (e.g., the multiple tabs of the current collector 710) and multiple battery cells 700 (e.g., the terminals 705 of multiple battery cells 700). The battery cells 700 can be electrically coupled in a series or parallel configuration with the battery cells 700 coupled with the current collector 710. The multiple battery cells 700 can be electrically coupled together via the current collector 710 to form a battery module or a battery pack, such as that discussed below and depicted in FIGS. 10-12, among others.

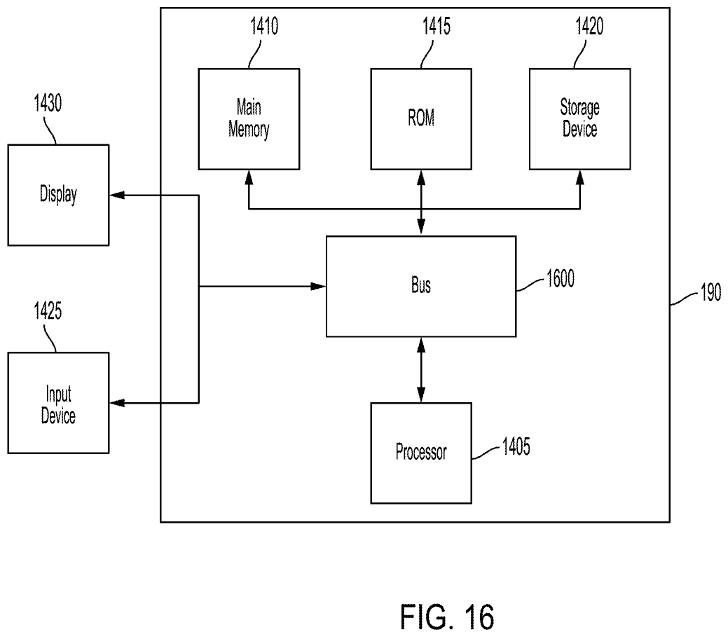

As depicted in FIGS. 1 and 16, among others, the laser welding device 170 can be communicably coupled with a computing system 190. The computing system 190, which is discussed in greater detail below with reference to FIG. 16, can control, monitor, or otherwise influence the operation of the laser welding device 170. For example, the computing system 190 can cause the laser welding device 170 to emit a laser towards the electrode stack tab 145. The computing system 190 can cause the laser welding device 170 to emit a single pulse beam 180, multiple single pulse beams 180, a continuous wave beam 180, multiple continuous wave beams 180, or some combination thereof. The computing system 190 can cause the laser welding device 170, the laser element 175, or the beam 180 to move relative to the electrode stack tab 145. For example, the computing system 190 can cause the beam 180 to move along the surface 150 of the electrode stack tab 145 to create the pattern 600. The computing system 190 can cause the laser welding device 170 to emit a first laser having first characteristics and a second laser having second characteristics. For example, the computing system 190 can cause the laser welding device 170 to emit a single pulse beam 180 during a first welding operation to pre-weld electrode tabs 135 together or to pre-weld the electrode stack tab 145 with the current collector 160. The computing system 190 can cause the laser welding device 170 to emit a continuous wave beam 180 to create the weld pool 500 to weld the electrode stack tab 145 with the current collector 160. The computing system 190 can alter the parameters or characteristics of the beam 180. For example, the computing system 190 can alter, change, or modify a diameter of the beam 180, a wavelength of the beam 180, an intensity of the beam 180, a power or energy density of the beam 180, a duration during which the beam 180 is emitted, a path along which the beam 180 moves, or some other parameter.

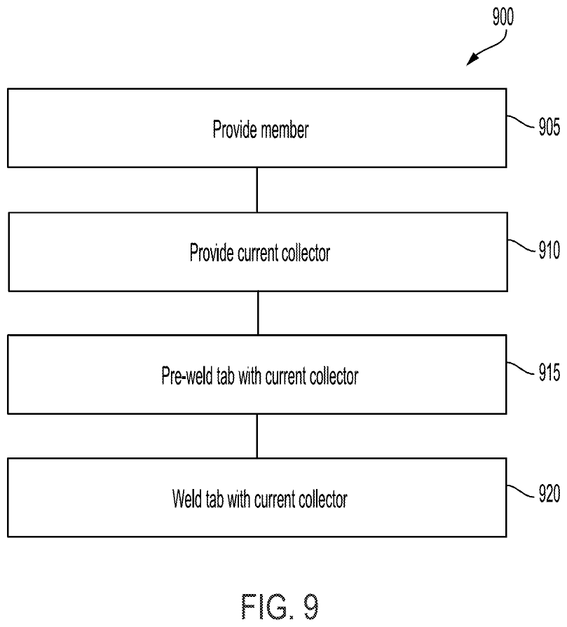

FIG. 9, among others, depicts a method 900. The method 900 can be a method of laser welding a first object with a second object. For example, the method 900 can be a method of welding the electrode stack tab 145 with the current collector 160 as herein described. The method 900 can be a method of welding the current collector 710 with the terminal 705 of a battery cell 700, for example. The method 900 can include one or more of ACTS 905-920.

The method 900 can include providing a member at ACT 905. For example, the method 900 can include providing an electrode stack tab 145 at ACT 905. The method 900 can include providing the battery cell 700 (e.g., the terminal 705 of the battery cell 700) at ACT 905. The electrode stack tab 145 can include at least one electrode tab 135 of at least one electrode, while the terminal 705 can be an electrical terminal of the battery cell 700 to electrically couple the battery cell 700 to another object (e.g., a current collector 710, another battery cell 700, or some other object). For example, the electrode stack tab 145 can be or include multiple electrode tabs 135 from multiple electrodes 105 or from multiple electrodes 110. Each of the electrode tabs 135 of the electrode stack tab 145 can be or include the same material. For example, the electrode tabs 135 can be copper electrode tabs coupled with an electrically conductive foil 130 of anode electrodes 105. The electrode tabs 135 can be aluminum electrode tabs coupled with the electrically conductive foil 140 of multiple cathode electrodes 110. The electrode stack tab 145 can include the multiple electrode tabs 135 stacked adjacent to one another, but not mechanically coupled together. For example, prior to any pre-welding operation, the electrode tabs 135 of the electrode stack tab 145 can move with respect to each other or a gap or space can exist between adjacent electrode tabs 135. The terminal 705 of the battery cell 700 can be an outward-facing terminal that is structure to facilitate or enable the coupling of the battery cell 700 with another object, such as a current collector of a battery module or battery pack, a terminal 705 of another battery cell 700, or some other object. For example, the terminal 705 can be a protrusion (e.g., a boss, a tab, a prong, or some other protrusion) extending from the battery cell 700 to facilitate electrical coupling. The terminal 705 can be an outer surface, such as a top surface, a sidewall, a bottom surface, or some other surface of the battery cell 700.

The method 900 can include providing the battery cell 700 at ACT 905. For example, the method 900 can include providing the terminal 705 of the battery cell 700 at ACT 905. The terminal 705 can be an electrical terminal of the battery cell 700 to electrically couple the battery cell 700 to another object (e.g., a current collector 710, another battery cell 700, or some other object). The terminal 705 of the battery cell 700 can be an outward-facing terminal that is structure to facilitate or enable the coupling of the battery cell 700 with another object, such as a current collector of a battery module or battery pack, a terminal 705 of another battery cell 700, or some other object. For example, the terminal 705 can be a protrusion (e.g., a boss, a tab, a prong, or some other protrusion) extending from the battery cell 700 to facilitate electrical coupling. The terminal 705 can be an outer surface, such as a top surface, a sidewall, a bottom surface, or some other surface of the battery cell 700.

The method 900 can include providing a current collector at ACT 910. For example, the method 900 can include providing the current collector 160 at ACT 910. The current collector 160 can be an electrically conductive object (e.g., metal plate, metal terminal, or some other object). For example, the current collector 160 can be an electrically conductive member within a housing of the battery cell (e.g., the housing 1300 shown in FIGS. 11-13 below) that can facilitate an electrical connection between the electrode stack 110 and some other object (e.g., a battery terminal or an electrode tab) located within or outside of the battery cell housing. The current collector 160 can be an electrically conductive member of an electrode stack (e.g., a jelly roll for a cylindrical battery cell or an electrode layer stack for a prismatic, pouch, or other cell). For example, the current collector 160 can be an electrode stack tab 145 of a second electrode stack 100. The current collector 160 can be coupled with at least one electrode 105 or at least one electrode 110 within the battery cell housing and at least one terminal (e.g., a battery cell terminal), where the terminal can be accessed outside of the housing of a battery cell. The current collector 160 can include a material composition that corresponds to a polarity of an electrode with which the current collector 160 is coupled. For example, the current collector 160 can be or include a copper material such that the current collector 160 can be coupled with one or more anode electrodes 105 (e.g., an electrode 105 including an anode battery active material 115, a copper electrically conductive foil layer 130, and a copper electrode tab 135). The current collector 160 can be or include an aluminum material such that the current collector 160 can be coupled with one or more cathode electrodes 110 (e.g., an electrode 110 including a cathode battery active material 120, an aluminum electrically conductive foil layer 140, and a corresponding aluminum electrode tab).

The method 900 can include providing the current collector 710 at ACT 910. The current collector 710 can be a current collector of a battery pack or battery module. For example, the current collector 710 can be an electrically conductive member of a battery pack or a battery module that can be electrically coupled to a busbar (e.g., another electrically conductive member), one or more battery cells 700, an electrical contactor, an electrical connector, an electrical switch, or some other device. The current collector 710 can electrically couple multiple battery cells 700 to form a battery module or battery pack, where the battery module or battery pack includes multiple battery cells that are electrically coupled in parallel, in series, or in some combination thereof. The current collector 710 can electrically couple multiple battery modules together to create a battery pack, where each battery module can itself include one or more battery cells 700. The current collector 710 can include a material composition that corresponds to a polarity of a terminal 705 with which the current collector 710 can be coupled. For example, the current collector 710 can be or include a copper material such that the current collector 710 can be electrically coupled with one or more terminals 705 corresponding to one or more anode electrodes 105 (e.g., an electrode 105 including an anode battery active material 115, a copper electrically conductive foil layer 130, and a copper electrode tab 135). The current collector 710 can be or include an aluminum material such that the current collector 710 can be coupled with one or more cathode electrodes 110 (e.g., an electrode 110 including a cathode battery active material 120, an aluminum electrically conductive foil layer 140, and a corresponding aluminum electrode tab).

The method 900 can include providing the member (e.g., the electrode stack tab 145 or the battery cell 700) at ACT 905 and providing the current collector (e.g., the current collector 160 or the current collector 710) at ACT 910 such that the member (e.g., the electrode stack tab 145 or the battery cell 700) is positioned against the current collector (e.g., the current collector 160 or the current collector 710). For example, the electrode stack tab 145 can be provided on (e.g., abutting, against, adjacent to, contacting, touching) the current collector 160. The current collector 160 can be provided underneath the electrode stack tab 145. For example, the surface 165 of the current collector 160 can contact a lower surface of the electrode stack tab 145 such that the surface 150 of the electrode stack tab 145 is exposed or accessible (e.g., accessible to the laser welding device 170). The current collector 710 can be provided on (e.g., abutting, against, adjacent to, contacting, touching) the battery cell 700. For example, the terminal 705 of the battery cell 700 can be provided underneath the current collector 710. For example, an upper surface of the terminal 705 can contact a lower surface of the current collector 710 such that the upper surface 715 of the current collector 710 is exposed or accessible (e.g., accessible to the laser welding device 170). The electrode stack tab 145 and the current collector 160 can be provided against each other, but the electrode stack tab 145 and the current collector 160 can move relative to each other prior to any pre-welding operation, welding operation, laser welding operation, or other joining operation.

The method 900 can include pre-welding the member (e.g., the electrode stack tab 145 or the terminal 705) with the current collector (e.g., the current collector 160 or the current collector 710) at ACT 915. For example, the method 900 can include pre-welding the electrode stack tab 145 with the current collector 160 at ACT 915. The method 900 can include pre-welding, by the laser welding device 170, the electrode stack tab 145 with the current collector 160. The laser welding device 170 can emit at least one single pulse beam 180 to pre-weld the electrode stack tab 145 with the current collector. For example, the laser welding device 170 can emit at least one single pulse beam 180 to pre-weld (e.g., join, couple, weld) the electrode tabs 135 of the electrode stack tab 145 together. The laser welding device 170 can emit the at least one single pulse beam 180 towards the electrode stack tab 145 to pre-weld the electrode stack tab 145 with the current collector 160. For example, as depicted in FIGS. 3-4, the laser welding device 170 can emit multiple single pulse beams 180 to create multiple joints 185, where the multiple joints 185 can pre-weld the electrode tabs 135 together and pre-weld the electrode stack tab 145 with the current collector 160 at ACT 915. The single pulse beam 180 can be a laser beam having discrete duration (e.g., less than 20 ms, 20-100 ms, or greater than 100 ms) that is directed towards a discrete location (e.g., a single point, spot, area, or region) of the surface 150 of the electrode stack tab 145. The laser welding device 170, the laser element 175 of the laser welding device 170, or the beam 180 can move with respect to the electrode stack tab 145 (e.g., the laser element 175 or the beam 180 can move along the path 300) such that multiple single pulse beams 180 can be emitted towards the surface 150 to create multiple joints 185 to pre-weld the electrode stack tab 145 with the current collector 160. The multiple joints 185 can follow the path 300, for example.

The method 900 can include pre-welding the current collector 710 with the battery cell (e.g., the terminal 705 of the battery cell 700) at ACT 915. The method 900 can include pre-welding, by the laser welding device 170, the current collector 710 with the terminal 705 of the battery cell 700. The laser welding device 170 can emit at least one single pulse beam 180 to pre-weld the current collector 710 with the terminal 705. For example, the laser welding device 170 can emit at least one single pulse beam 180 towards the current collector 710 to pre-weld the current collector 710 with the terminal 705. For example, as depicted in FIGS. 7 and 8, among others, the laser welding device 170 can emit multiple single pulse beams 180 to create multiple joints 185, where the multiple joints 185 can pre-weld the current collector 710 with the terminal 705 at ACT 915. The single pulse beam 180 can be a laser beam having discrete duration (e.g., less than 20 ms, 20-100 ms, or greater than 100 ms) that is directed towards a discrete location (e.g., a single point, spot, area, or region) of the surface 715 of the current collector 710. The laser welding device 170, the laser element 175 of the laser welding device 170, or the beam 180 can move with respect to the current collector 710 (e.g., the laser element 175 or the beam 180 can move along the path 300) such that multiple single pulse beams 180 can be emitted towards the surface 150 to create multiple joints 185 to pre-weld the current collector 710 with the terminal 705. The multiple joints 185 can follow the path 300, for example. The laser welding device 170 can emit multiple single pulse beams in sequence, simultaneously, or in groups.

The method 900 can include welding the member (e.g., the electrode stack tab 145 or the battery cell 700) with the current collector (e.g., the current collector 160 or the current collector 710) at ACT 920. For example, the method 900 can include welding the electrode stack tab 145 with the current collector 160 at ACT 920. The method 900 can include welding, by the laser welding device 170, the electrode stack tab 145 with the current collector 160. For example, the laser welding device 170 can emit a continuous wave beam 180 to weld the electrode stack tab 145 with the current collector 160. The laser welding device 170 can emit the continuous wave beam 180 to melt at least a portion of the electrode stack tab 145 and the current collector 160 to create a weld pool 500. The weld pool 500 can cause the current collector 160 and the electrode stack tab 145 to be welded, joined, coupled, or mated. The laser welding device 170 can emit the continuous wave beam 180 towards the surface 150 of the electrode stack tab 145 according to a pattern, such as the pattern 600 or some other pattern. The continuous wave beam 180 can be a laser beam having relatively long duration (e.g., greater than one second, 1-3 seconds, or some other duration) as compared to the single pulse beam 180 emitted at ACT 915. The continuous wave beam 180 can be a laser beam that is directed towards a relatively large location (e.g., a single point, spot, area, or region) of the surface 150 of the electrode stack tab 145 as compared to the single pulse beam 180 emitted at ACT 915. The laser welding device 170, the laser element 175 of the laser welding device 170, or the beam 180 can move with respect to the electrode stack tab 145 (e.g., along the path 300) such that the continuous wave beam 180 can be emitted towards the surface 150 to create the weld pool 500 to weld (e.g., join, couple, mechanically bind, electrically couple) the electrode stack tab 145 with the current collector 160.

The method 900 can include welding the current collector 710 with the battery cell 700 (e.g., the terminal 705 of the battery cell 700) at ACT 920. The method 900 can include welding, by the laser welding device 170, the current collector 710 with the terminal 705 of the battery cell 700. For example, the laser welding device 170 can emit a continuous wave beam 180 to weld the current collector 710 with the terminal 705. The laser welding device 170 can emit the continuous wave beam 180 to melt at least a portion of the current collector 710 and the terminal 705 to create a weld pool 500. The weld pool 500 can cause the current collector 710 and the terminal 705 to be welded, joined, coupled, or mated. The laser welding device 170 can emit the continuous wave beam 180 towards the surface 715 of the current collector 710 according to a pattern, such as the pattern 600 or some other pattern. The continuous wave beam 180 can be a laser beam having relatively long duration (e.g., greater than one second, 1-3 seconds, or some other duration) as compared to the single pulse beam 180 emitted at ACT 915. The continuous wave beam 180 can be a laser beam that is directed towards a relatively large location (e.g., a single point, spot, area, or region) of the surface 715 of the current collector 710 as compared to the single pulse beam 180 emitted at ACT 915. The laser welding device 170, the laser element 175 of the laser welding device 170, or the beam 180 can move with respect to the current collector 710 (e.g., along the path 300) such that the continuous wave beam 180 can be emitted towards the surface 715 to create the weld pool 500 to weld (e.g., join, couple, mechanically bind, electrically couple) the current collector 710 with the terminal 705.

FIG. 10 depicts an example cross-sectional view 1000 of an electric vehicle 1005 installed with at least one battery pack 1010. Electric vehicles 1005 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 1010 can also be used as an energy storage system to power a building, such as a residential home or commercial building. Electric vehicles 1005 can be fully electric or partially electric (e.g., plug-in hybrid) and further, electric vehicles 1005 can be fully autonomous, partially autonomous, or unmanned. Electric vehicles 1005 can also be human operated or non-autonomous. Electric vehicles 1005 such as electric trucks or automobiles can include on-board battery packs 1010, batteries 1015 or battery modules 1015, or battery cells 700 to power the electric vehicles. The electric vehicle 1005 can include a chassis 1025 (e.g., a frame, internal frame, or support structure). The chassis 1025 can support various components of the electric vehicle 1005. The chassis 1025 can span a front portion 1030 (e.g., a hood or bonnet portion), a body portion 1035, and a rear portion 1040 (e.g., a trunk, payload, or boot portion) of the electric vehicle 1005. The battery pack 1010 can be installed or placed within the electric vehicle 1005. For example, the battery pack 1010 can be installed on the chassis 1025 of the electric vehicle 1005 within one or more of the front portion 1030, the body portion 1035, or the rear portion 1040. The battery pack 1010 can include or connect with at least one busbar, e.g., a current collector element. For example, the first busbar 1045 and the second busbar 1050 can include electrically conductive material to connect or otherwise electrically couple the battery 1015, the battery modules 1015, or the battery cells 700 with other electrical components of the electric vehicle 1005 to provide electrical power to various systems or components of the electric vehicle 1005.

FIG. 11 depicts an example battery pack 1010. Referring to FIG. 11, among others, the battery pack 1010 can provide power to electric vehicle 1005. Battery packs 1010 can include any arrangement or network of electrical, electronic, mechanical, or electromechanical devices to power a vehicle of any type, such as the electric vehicle 1005. The battery pack 1010 can include at least one housing 1100. The housing 1100 can include at least one battery module 1015 or at least one battery cell 700, as well as other battery pack components. The battery module 1015 can be or can include one or more groups of prismatic cells, cylindrical cells, pouch cells, or other form factors of battery cells 700. The housing 1100 can include a shield on the bottom or underneath the battery module 1015 to protect the battery module 1015 and/or cells 700 from external conditions, for example if the electric vehicle 1005 is driven over rough terrains (e.g., off-road, trenches, rocks, etc.) The battery pack 1010 can include at least one cooling line 1105 that can distribute fluid through the battery pack 1010 as part of a thermal/temperature control or heat exchange system that can also include at least one thermal component (e.g., cold plate) 1110. The thermal component 1110 can be positioned in relation to a top submodule and a bottom submodule, such as in between the top and bottom submodules, among other possibilities. The battery pack 1010 can include any number of thermal components 1110. For example, there can be one or more thermal components 1110 per battery pack 1010, or per battery module 1015. At least one cooling line 1105 can be coupled with, part of, or independent from the thermal component 1110.

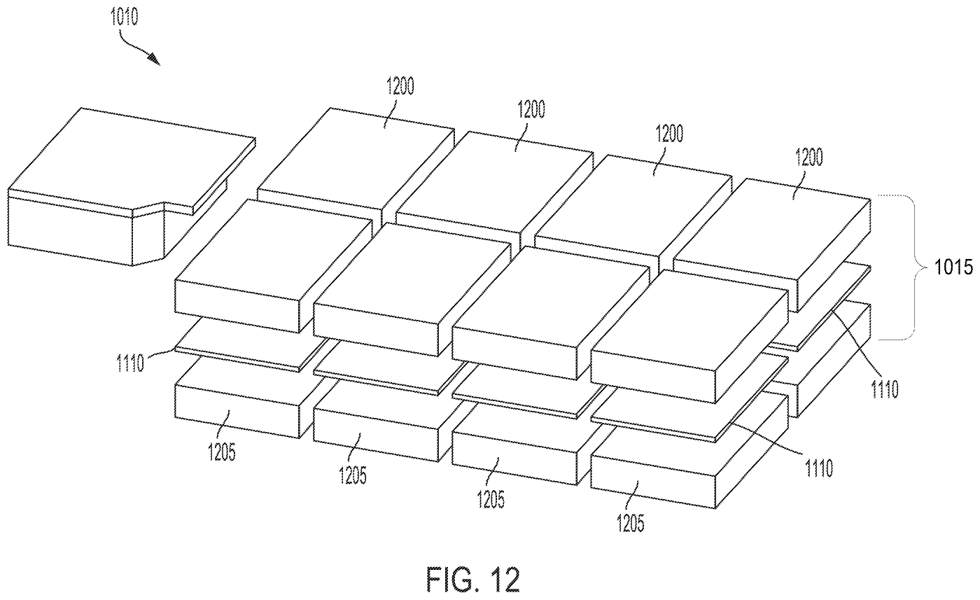

FIG. 12 depicts example battery modules 1015, and FIGS. 13, 14, and 15 depict an example cross sectional view of a battery cell 700. The battery modules 1015 can include at least one submodule. For example, the battery modules 1015 can include at least one first (e.g., top) submodule 1200 or at least one second (e.g., bottom) submodule 1205. At least one thermal component 1110 can be disposed between the top submodule 1200 and the bottom submodule 1205. For example, one thermal component 1110 can be configured for heat exchange with one battery module 1015. The thermal component 1110 can be disposed or thermally coupled between the top submodule 1200 and the bottom submodule 1205. One thermal component 1110 can also be thermally coupled with more than one battery module 1015 (or more than two submodules 1200, 1205). The thermal components 1110 shown adjacent to each other can be combined into a single thermal component 1110 that spans the size of one or more submodules 1200 or 1205. The thermal component 1110 can be positioned underneath submodule 1200 and over submodule 1205, in between submodules 1200 and 1205, on one or more sides of submodules 1200, 1205, among other possibilities. The thermal component 1110 can be disposed in sidewalls, cross members, structural beams, among various other components of the battery pack, such as battery pack 1010 described above. The battery submodules 1200, 1205 can collectively form one battery module 1015. In some examples each submodule 1200, 1205 can be considered as a complete battery module 1015, rather than a submodule.

The battery modules 1015 can each include a plurality of battery cells 700. The battery modules 1015 can be disposed within the housing 1100 of the battery pack 1010. The battery modules 1015 can include battery cells 700 that are cylindrical cells or prismatic cells, for example. The battery module 1015 can operate as a modular unit of battery cells 700. For example, a battery module 1015 can collect current or electrical power from the battery cells 700 that are included in the battery module 1015 and can provide the current or electrical power as output from the battery pack 1010. The battery pack 1010 can include any number of battery modules 1015. For example, the battery pack can have one, two, three, four, five, six, seven, eight, nine, ten, eleven, twelve or other number of battery modules 1015 disposed in the housing 1100. It should also be noted that each battery module 1015 may include a top submodule 1200 and a bottom submodule 1205, possibly with a thermal component 1110 in between the top submodule 1200 and the bottom submodule 1205. The battery pack 1010 can include or define a plurality of areas for positioning of the battery module 1015 and/or cells 700. The battery modules 1015 can be square, rectangular, circular, triangular, symmetrical, or asymmetrical. In some examples, battery modules 1015 may be different shapes, such that some battery modules 1015 are rectangular but other battery modules 1015 are square shaped, among other possibilities. The battery module 1015 can include or define a plurality of slots, holders, or containers for a plurality of battery cells 700. It should be noted the illustrations and descriptions herein are provided for example purposes and should not be interpreted as limiting. For example, the battery cells 700 can be inserted in the battery pack 1010 without battery modules 1000 and 1205. The battery cells 700 can be disposed in the battery pack 1010 in a cell-to-pack configuration without modules 1000 and 1205, among other possibilities.

The battery cells 700 can include the electrode stack 100 having multiple electrodes 105 and multiple electrodes 110. The battery cell 700 can include the electrode stack tab 145 including multiple electrode tabs 135 coupled together. The battery cell 700 can include the current collector 160. For example, the current collector 160 can be coupled with the electrode stack tab 145. The current collector 160 can be pre-welded with the electrode stack tab 145 and welded with the electrode stack tab 145 according to two laser welding operations. For example, the current collector 160 can be pre-welded with the electrode stack tab 145 by at least one single pulse beam 180 emitted from a laser welding device 170, the single pulse beam 180 to create the joint 185 between the electrode stack tab 145 and the current collector 160. The current collector 160 can be welded with the electrode stack tab 145 by at least one continuous wave beam 180 emitted by the laser welding device 170 to create a weld pool. The current collector can be coupled with a terminal 1305 or a terminal 1310, as depicted in FIGS. 13-15 and as discussed below.

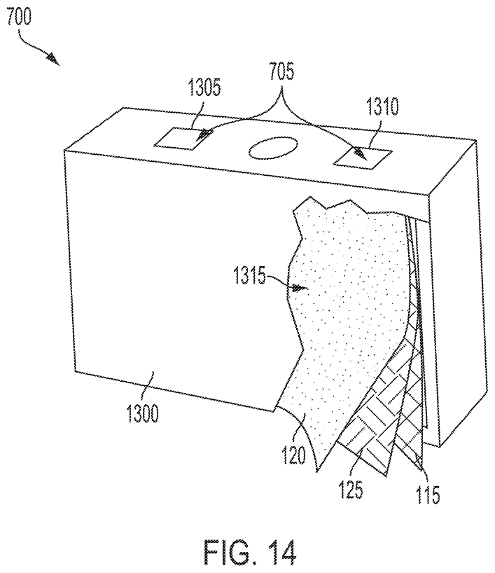

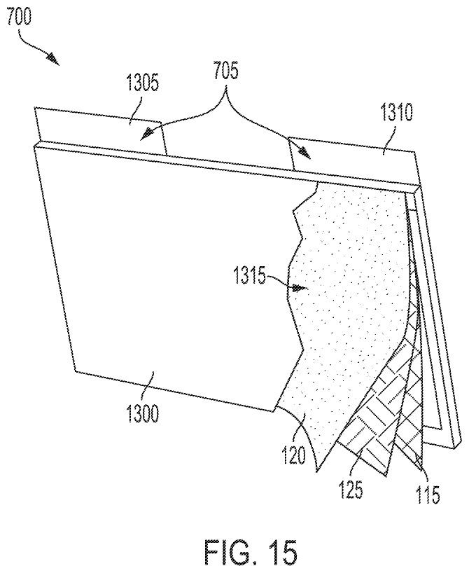

Battery cells 700 have a variety of form factors, shapes, or sizes. For example, battery cells 700 can have a cylindrical, rectangular, square, cubic, flat, pouch, elongated or prismatic form factor. As depicted in FIG. 13, for example, the battery cell 700 can be cylindrical. As depicted in FIG. 14, for example, the battery cell 700 can be prismatic. As depicted in FIG. 15, for example, the battery cell 700 can include a pouch form factor. Battery cells 700 can be assembled, for example, by inserting a winded or stacked electrode roll (e.g., a jelly roll) including electrolyte material into at least one battery cell housing 1300. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 700 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 700. The housing 1300 can be of various shapes, including cylindrical or rectangular, for example. Electrical connections can be made between the electrolyte material and components of the battery cell 700. For example, electrical connections to the electrodes with at least some of the electrolyte material can be formed at two points or areas of the battery cell 700, for example to form at least one terminal 705. The terminal 705 can be a first polarity terminal 1305 (e.g., a positive or anode terminal). The terminal 705 can be a second polarity terminal 1310 (e.g., a negative or cathode terminal). The polarity terminals can be made from electrically conductive materials to carry electrical current from the battery cell 700 to an electrical load, such as a component or system of the electric vehicle 1005.

For example, the battery cell 700 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 700 to separate the anode and cathode from each other and to facilitate transfer of lithium ions between the anode and cathode. It should be noted that battery cell 700 can also take the form of a solid-state battery cell developed using solid electrodes and solid electrolytes. Solid electrodes or electrolytes can be or include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B═Al, Ti), garnet-type with formula A₃B₂(XO₄)₃ (A=Ca, Sr, Ba and X═Nb, Ta), lithium phosphorous oxy-nitride (LiₓPO_{y}N₂). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X═Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

The battery cell 700 can be included in battery modules 1015 or battery packs 1010 to power components of the electric vehicle 1005. The battery cell housing 1300 can be disposed in the battery module 1015, the battery pack 1010, or a battery array installed in the electric vehicle 1005. The housing 1300 can be of any shape, such as cylindrical with a circular (e.g., as depicted in FIG. 13, among others), elliptical, or ovular base, among others. The shape of the housing 1300 can also be prismatic with a polygonal base, as shown in FIG. 14, among others. As shown in FIG. 15, among others, the housing 1300 can include a pouch form factor. The housing 1300 can include other form factors, such as a triangle, a square, a rectangle, a pentagon, and a hexagon, among others. In some embodiments, the battery pack may not include modules (e.g., module-free). For example, the battery pack can have a module-free or cell-to-pack configuration where the battery cells are arranged directly into a battery pack without assembly into a module.

The housing 1300 of the battery cell 700 can include one or more materials with various electrical conductivity or thermal conductivity, or a combination thereof. The electrically conductive and thermally conductive material for the housing 1300 of the battery cell 700 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 1300 of the battery cell 700 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 1300 of the battery cell 700 is prismatic (e.g., as depicted in FIG. 14, among others) or cylindrical (e.g., as depicted in FIG. 13, among others), the housing 1300 can include a rigid or semi-rigid material such that the housing 1300 is rigid or semi-rigid (e.g., not easily deformed or manipulated into another shape or form factor). In examples where the housing 1300 includes a pouch form factor (e.g., as depicted in FIG. 15, among others), the housing 1300 can include a flexible, malleable, or non-rigid material such that the housing 1300 can be bent, deformed, manipulated into another form factor or shape.

The battery cell 700 can include at least one anode layer 115, which can be disposed within the cavity 1315 defined by the housing 1300. The anode layer 115 can include a first redox potential. The anode layer 115 can receive electrical current into the battery cell 700 and output electrons during the operation of the battery cell 700 (e.g., charging or discharging of the battery cell 700). The anode layer 115 can include an active substance. The active substance can include, for example, an activated carbon or a material infused with conductive materials (e.g., artificial or natural graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp2 hybridization), Li metal anode, or a silicon-based carbon composite anode, or other lithium alloy anodes (Li—Mg, Li—Al, Li—Ag alloy etc.) or composite anodes consisting of lithium and carbon, silicon and carbon or other compounds. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 700 can include at least one cathode layer 120 (e.g., a composite cathode layer compound cathode layer, a compound cathode, a composite cathode, or a cathode). The cathode layer 120 can include a second redox potential that can be different than the first redox potential of the anode layer 115. The cathode layer 120 can be disposed within the cavity 1315. The cathode layer 120 can output electrical current out from the battery cell 700 and can receive electrons during the discharging of the battery cell 700. The cathode layer 120 can also receive lithium ions during the discharging of the battery cell 700. Conversely, the cathode layer 120 can receive electrical current into the battery cell 700 and can output electrons during the charging of the battery cell 700. The cathode layer 120 can release lithium ions during the charging of the battery cell 700.

The battery cell 700 can include a layer 125 disposed within the cavity 1315. The layer 125 can include a solid electrolyte layer. The layer 125 can include a separator wetted by a liquid electrolyte. The layer 125 can include a polymeric material. The layer 125 can include a polymer separator. The layer 125 can be arranged between the anode layer 115 and the cathode layer 120 to separate the anode layer 115 and the cathode layer 120. The polymer separator can physically separate the anode and cathode from a cell short circuit. A separator can be wetted with a liquid electrolyte. The liquid electrolyte can be diffused into the anode layer 115. The liquid electrolyte can be diffused into the cathode layer 120. The layer 125 can help transfer ions (e.g., Li⁺ ions) between the anode layer 115 and the cathode layer 120. The layer 125 can transfer Lit cations from the anode layer 115 to the cathode layer 120 during the discharge operation of the battery cell 700. The layer 125 can transfer lithium ions from the cathode layer 120 to the anode layer 115 during the charge operation of the battery cell 700.

The redox potential of layers (e.g., the first redox potential of the anode layer 115 or the second redox potential of the cathode layer 120) can vary based on a chemistry of the respective layer or a chemistry of the battery cell 700. For example, lithium-ion batteries can include an LFP (lithium iron phosphate) chemistry, an LMFP (lithium manganese iron phosphate) chemistry, an NMC (Nickel Manganese Cobalt) chemistry, an NCA (Nickel Cobalt Aluminum) chemistry, an OLO (Over Lithiated Oxide) chemistry, or an LCO (lithium cobalt oxide) chemistry for a cathode layer (e.g., the cathode layer 120). Lithium-ion batteries can include a graphite chemistry, a silicon-graphite chemistry, or a lithium metal chemistry for the anode layer (e.g., the anode layer 115).

For example, lithium-ion batteries can include an olivine phosphate (LiMPO₄, M=Fₑ and/or Co and/or Mn and/or Ni)) chemistry, LISICON or NASICON Phosphates (Li₃M₂(PO₄)₃ and LiMPO₄Oₓ, M=Ti, V, Mn, Cr, and Zr), for example lithium iron phosphate (LFP), lithium iron manganese phosphate (LMFP), layered oxides (LiMO₂, M=Ni and/or Co and/or Mn and/or Fe and/or Al and/or Mg) examples, NMC (Nickel Manganese Cobalt) chemistry, an NCA (Nickel Cobalt Aluminum) chemistry, or an LCO (lithium cobalt oxide) chemistry for a cathode layer, lithium rich layer oxides (Li₁₊ₓM₁₋ₓO₂) (Ni, and/or Mn, and/or Co), (OLO or LMR), spinel (LiMn₂O₄) and high voltage spinels (LiMn_{1.5}Ni_{0.5}O₄), disordered rock salt, Fluorophosphates Li₂FePO₄F (M=Fe, Co, Ni) and Fluorosulfates LiMSO₄F (M=Co, Ni, Mn) (e.g., the cathode layer 120). Lithium-ion batteries can include a graphite chemistry, a silicon-graphite chemistry, or a lithium metal chemistry for the anode layer (e.g., the anode layer 115). For example, a cathode layer having an LFP chemistry can have a redox potential of 3.4 V vs. Li/Lit, while an anode layer having a graphite chemistry can have a 0.2 V vs. Li/Li⁺ redox potential.

Electrode layers can include anode active material or cathode active material, commonly in addition to a conductive carbon material, a binder, or other additives as a coating on a current collector (metal foil). The chemical composition of the electrode layers can affect the redox potential of the electrode layers. For example, cathode layers (e.g., the cathode layer 120) can include medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and lithium iron manganese phosphate (“LMFP”). Anode layers (e.g., the anode layer 115) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The layer 125 can include or be made of a liquid electrolyte material. For example, the layer 125 can be or include at least one layer of polymeric material (e.g., polypropylene, polyethylene, or other material) including pores that are wetted (e.g., saturated with, soaked with, receive, are filled with) a liquid electrolyte substance to enable ions to move between electrodes. The liquid electrolyte material can include a lithium salt dissolved in a solvent. The lithium salt for the liquid electrolyte material for the layer 125 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. Liquid electrolyte is not necessarily disposed near the layer 125, but the liquid electrolyte can fill the battery cells 700 in many different ways. The layer 125 can include or be made of a solid electrolyte material, such as a ceramic electrolyte material, polymer electrolyte material, or a glassy electrolyte material, or among others, or any combination thereof.

In some embodiments, the solid electrolyte film can include at least one layer of a solid electrolyte. Solid electrolyte materials of the solid electrolyte layer can include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr. La, and B═Al, Ti), garnet-type with formula A₃B₂(XO₄)₃ (A=Ca, Sr. Ba and X═Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X═Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

In examples where the layer 125 includes a liquid electrolyte material, the layer 125 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The layer 125 can include at least one additive. The additives can be or include vinylidene carbonate, fluoroethylene carbonate, ethyl propionate, methyl propionate, methyl acetate, ethyl acetate, or a mixture of any two or more thereof. The layer 125 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the layer 125 from greater than 0 M to about 1.5 M. Once disposed to the battery cell 700, liquid electrolyte can be present and touching battery subcomponents present within the battery cell 700. The battery subcomponents can include the cathode, the anode, the separator, the current collector, etc.

FIG. 16 depicts an example block diagram of an example computer system 190. The computer system or computing device 190 can include or be used to implement a data processing system or its components. The computing system 190 includes at least one bus 1600 or other communication component for communicating information and at least one processor 1605 or processing circuit coupled to the bus 1600 for processing information. The computing system 190 can also include one or more processors 1605 or processing circuits coupled to the bus for processing information. The computing system 190 also includes at least one main memory 1610, such as a random access memory (RAM) or other dynamic storage device, coupled to the bus 1600 for storing information, and instructions to be executed by the processor 1605. The main memory 1610 can be used for storing information during execution of instructions by the processor 1605. The computing system 190 may further include at least one read only memory (ROM) 1615 or other static storage device coupled to the bus 1600 for storing static information and instructions for the processor 1605. A storage device 1620, such as a solid-state device, magnetic disk, or optical disk, can be coupled to the bus 1600 to persistently store information and instructions.

The computing system 190 may be coupled via the bus 1600 to a display 1630, such as a liquid crystal display, or active matrix display, for displaying information to a user such as a driver of the electric vehicle 1005 or other end user. An input device 1625, such as a keyboard or voice interface may be coupled to the bus 1600 for communicating information and commands to the processor 1605. The input device 1625 can include a touch screen display 1630. The input device 1625 can also include a cursor control, such as a mouse, a trackball, or cursor direction keys, for communicating direction information and command selections to the processor 1605 and for controlling cursor movement on the display 1630.

The processes, systems and methods described herein can be implemented by the computing system 190 in response to the processor 1605 executing an arrangement of instructions contained in main memory 1610. Such instructions can be read into main memory 1610 from another computer-readable medium, such as the storage device 1620. Execution of the arrangement of instructions contained in main memory 1610 causes the computing system 190 to perform the illustrative processes described herein. One or more processors in a multi-processing arrangement may also be employed to execute the instructions contained in main memory 1610. Hard-wired circuitry can be used in place of or in combination with software instructions together with the systems and methods described herein. Systems and methods described herein are not limited to any specific combination of hardware circuitry and software.

Although an example computing system has been described in FIG. 16, the subject matter including the operations described in this specification can be implemented in other types of digital electronic circuitry, or in computer software, firmware, or hardware, including the structures disclosed in this specification and their structural equivalents, or in combinations of one or more of them.

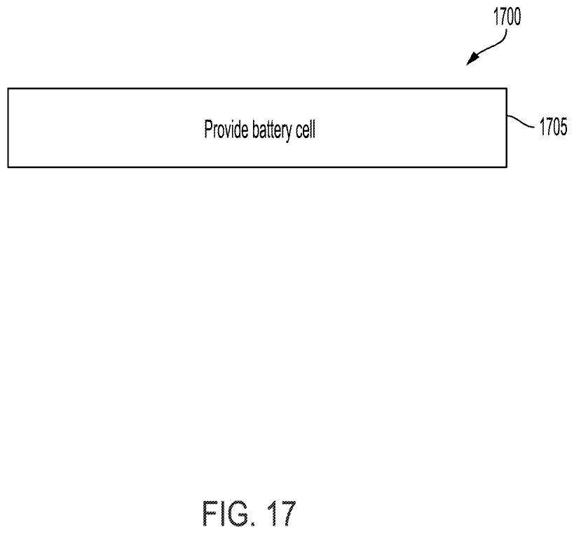

FIG. 17, among others, depicts a method 1700. The method 1700 can include providing a battery cell at ACT 1705. The battery cell can be the battery cell 700. The battery cell 700 can include the electrode stack 100 depicted in FIGS. 1-6, among others. The electrode stack 100 can include an electrode stack tab 145 including multiple electrode tabs 135. The battery cell 700 can include the electrode stack tab 145 coupled with a current collector 160. For example, the battery cell 700 can include the electrode stack tab 145 mechanically and electrically coupled with the current collector 160. The electrode stack tab 145 can be pre-welded with the current collector 160 according to a first laser welding operation. For example, the first laser welding operation can include the laser welding device 170 emitting a first beam 180 to pre-weld the electrode stack tab 145 with the current collector 160. The first beam 180 can be at least one single pulse beam 180 to create a joint 185 between the electrode tabs 135 of the electrode stack tab 145 and between the electrode stack tab 145 and the current collector. The first laser welding operation can include pre-welding the electrode stack tab 145 with the current collector via multiple joints 185 created by multiple single pulse beams 180. The multiple single pulse beams can be emitted simultaneously, in sequence, or in groups. The electrode stack tab 145 can be welded with the current collector 160 according to a second laser welding operation. For example, the second laser welding operation can include the laser welding device 170 emitting a continuous wave beam 180 to weld the electrode stack tab 145 with the current collector 160. The continuous wave beam 180 can create a weld pool 500 to join (e.g., coupled, weld, adhere) the electrode stack tab 145 with the current collector 160. The continuous wave beam 180 can move relative to the surface 150 of the electrode stack tab 145 according to the pattern 600 or some other pattern or path to create the weld pool 500.

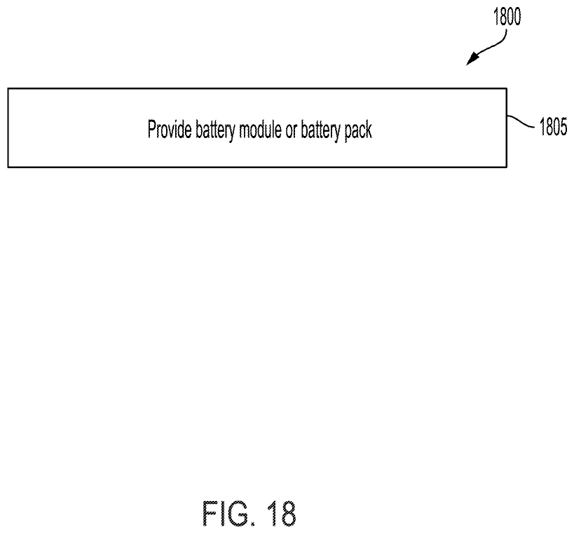

FIG. 18, among others, depicts a method 1800. The method 1800 can include providing a battery module or a battery pack at ACT 1805. The battery module can be the battery module 1015. The battery pack can be the battery pack 1010. The battery module or the battery pack can include one or more battery cells 700 coupled with a current collector 710. For example, the current collector 710 can be an electrically conductive current collector that can be electrically coupled with one or more battery cells 700. The current collector 710 can electrically couple multiple battery cells 700 together to form the battery module or battery pack such that the battery module or battery pack can use or include multiple battery cells 700, as discussed above and as depicted in FIGS. 10-12. The battery pack or the battery module can include the battery cell 700 mechanically and electrically coupled with the current collector 710. For example, a terminal 705 of the battery cell 700 can be pre-welded with the current collector 710 according to a first laser welding operation. The first laser welding operation can include the laser welding device 170 emitting a first beam 180 to pre-weld the terminal 705 of the battery cell 700 with the current collector 710. The first beam 180 can be at least one single pulse beam 180 to create at least one joint 185 between the current collector 710 and the terminal 705 of the battery cell 700. The first laser welding operation can include pre-welding the current collector 710 with the terminal 705 via multiple joints 185 created by multiple single pulse beams 180. The multiple single pulse beams 180 can be emitted simultaneously, in sequence, or in groups. The current collector 710 can be welded with the terminal 705 of the battery cell 700 according to a second laser welding operation. For example, the second laser welding operation can include the laser welding device 170 emitting a continuous wave beam 180 to weld the current collector 710 with the terminal 705. The continuous wave beam 180 can create a weld pool 500 to join (e.g., coupled, weld, adhere) the current collector 710 with the terminal 705 of the battery cell 700. The continuous wave beam 180 can move relative to the surface 715 of the current collector 710 according to the pattern 600 or some other pattern or path to create the weld pool 500.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. For example, electrode described as being anode electrodes or as cathode electrodes can be reversed or switched. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A method of manufacturing a battery cell, comprising:
emitting, by a laser welding device for a first duration, a first beam to pre-weld a first member with a current collector; and
emitting, by the laser welding device for a second duration, a second beam to weld the first member with the current collector;
wherein the first duration of the first beam is less than the second duration of the second beam.

2. The method of claim 1, comprising:
providing the first member, the first member comprising an electrode stack tab having a plurality of electrode tabs stacked together;
wherein emitting the first beam joins the plurality of electrode tabs together to form the electrode stack tab.

3. The method of claim 1, comprising:
providing the first member, the first member comprising an electrode stack tab having a plurality of electrode tabs;
wherein emitting the first beam joins the plurality of electrode tabs together and substantially eliminates a space between the plurality of electrode tabs to form the electrode stack tab.

4. The method of claim 1, comprising:
providing the first member, the first member comprising a terminal of a battery cell;
wherein emitting the first beam mechanically couples the terminal of the battery cell with the current collector.

5. The method of claim 1, wherein the first beam is a single pulse beam and the second beam is a continuous wave beam, the method further comprising:
providing the first member, the first member comprising a terminal of a first battery cell;
emitting, by the laser welding device for a third duration, a second single pulse beam to pre-weld a terminal of a second battery cell with the current collector; and
emitting, by the laser welding device for a fourth duration, a second continuous wave beam to weld the terminal of the second battery cell with the current collector;
wherein the current collector comprises an electrically conductive material to electrically couple the battery cell with the second battery cell.

6. The method of claim 1, wherein the first beam includes a first energy density that is greater than a second energy density of the second beam.

7. The method of claim 1, comprising:
the first beam to cause a localized reaction within the first member and the current collector to create a joint;
the second beam causing a linear thermal reaction within the first member and the current collector to create a weld pool.

8. The method of claim 1, comprising:
emitting, by the laser welding device, a plurality of first beams to pre-weld the first member with the current collector;
wherein each of the plurality of first beams creates a joint to mechanically couple the first member with the current collector.

9. The method of claim 1, comprising:
emitting, by the laser welding device, a plurality of first beams to pre-weld the first member with the current collector;
wherein each of the plurality of first beams causes a localized reaction within the first member and the current collector to create a joint to mechanically couple the first member with the current collector.

10. The method of claim 1, comprising:
emitting, by the laser welding device, a plurality of first beams to create a plurality of joints to mechanically couple the first member with the current collector the plurality of joints arranged along a path.

11. The method of claim 1, comprising:
emitting, by the laser welding device, a plurality of first beams to create a plurality of joints to mechanically couple the first member with the current collector the plurality of joints arranged along a path;
wherein emitting the second beam comprises emitting the second beam along the path to at least partially overlap one or more joints of the plurality of joints.

12. The method of claim 1, comprising:
emitting, by the laser welding device, a plurality of first beams to create a plurality of joints to mechanically couple the first member with the current collector the plurality of joints arranged along a linear path;
wherein emitting the second beam comprises emitting the second beam along the linear path to at least partially overlap one or more joints of the plurality of joints.

13. The method of claim 1, comprising:
wherein emitting the second beam includes moving the second beam relative to a surface of the first member according to a pattern.

14. A battery cell, comprising:
a plurality of electrodes having a first polarity and a plurality of electrode tabs, the plurality of electrode tabs forming an electrode stack tab; and
a current collector having the first polarity, the current collector pre-welded with the electrode stack tab via a plurality of joints and welded with the electrode stack tab via a weld pool.

15. The battery cell of claim 14, wherein a joint of the plurality of joints comprises a point that extends from a surface of the electrode stack tab past a surface of the current collector and into the current collector to join the electrode stack tab with the current collector.

16. The battery cell of claim 14, comprising:
the weld pool extending from a surface of the electrode stack tab and into the current collector to join the electrode stack tab with the current collector.

17. The battery cell of claim 14, comprising:
the weld pool extending a first depth from a surface of the electrode stack tab and into the current collector to join the electrode stack tab with the current collector; and
a joint of the plurality of joints comprising a point extending a second depth from the surface of the electrode stack tab past a surface of the current collector and into the current collector to join the electrode stack tab with the current collector.

18. The battery cell of claim 14, comprising:
a terminal electrically coupled with the current collector; and
a second current collector, the second current collector pre-welded with the terminal via a second plurality of joints and welded with the terminal via a second weld pool.

19. An electric vehicle, comprising:
a battery pack including a battery cell, the battery cell comprising:
a plurality of electrodes having a first polarity and a plurality of electrode tabs, the plurality of electrode tabs forming an electrode stack tab; and
a current collector having the first polarity, the current collector pre-welded with the electrode stack tab via a plurality of joints and welded with the electrode stack tab via a weld pool.

20. The electric vehicle of claim 19, comprising:
the battery pack comprising a second battery cell and a second current collector, the second current collector electrically coupled with the battery cell and the second battery cell;
the battery cell comprising a terminal, the terminal pre-welded with the second current collector via a second plurality of joints and welded with the second current collector via a second weld pool.
